(19) United States
(12) Patent Application Publication
(10) Pub. No.: US 2020/0401916 A1
(43) Pub. Date: Dec. 24, 2020

(54) SYSTEMS AND METHODS FOR TRAINING GENERATIVE MACHINE LEARNING MODELS

(71) Applicant: D-WAVE SYSTEMS INC., Burnaby (CA)

(72) Inventors: Jason T. Rolfe, Vancouver (CA); Amir H. Khoshaman, Vancouver (CA); Arash Vahdat, Coquitlam (CA); Mohammad H. Amin, Coquitlam (CA); Evgeny A. Andriyash, Vancouver (CA); William G. Macready, West Vancouver (CA)

(21) Appl. No.: 16/968,465

(22) PCT Filed: Feb. 7, 2019
(86) PCT No.: PCT/US2019/017124

§ 371 Date: Aug. 7, 2020

Related U.S. Application Data
(60) Provisional application No. 62/628,384, filed on Feb. 9, 2018.
(60) Provisional application No. 62/637,268, filed on Mar. 1, 2018.
(60) Provisional application No. 62/648,237, filed on Mar. 26, 2018.
(60) Provisional application No. 62/667,350, filed on May 4, 2018.
(60) Provisional application No. 62/673,013, filed on May 17, 2018.

(51) Int. Cl. G06N 5/04; G06N 20/00

(52) U.S. Cl. CPC G06N 5/04; G06N 20/00

(57) ABSTRACT

Generative and inference machine learning models with discrete-variable latent spaces are provided. Discrete variables may be transformed by a smoothing transformation with overlapping conditional distributions or made natively reparametrizable by definition over a GUMBEL distribution. Models may be trained by sampling from different models in the positive and negative phase and/or sample with different frequency in the positive and negative phase. Machine learning models may be defined over high-dimensional quantum statistical systems near a phase transition to take advantage of long-range correlations. Machine learning models may be defined over graph-representable input spaces and use multiple spanning trees to form latent representations. Machine learning models may be relaxed via continuous proxies to support a greater range of training techniques, such as importance weighting. Example architectures for (discrete) variational autoencoders using such techniques are also provided. Techniques for improving training efficacy and sparsity of variational autoencoders are also provided.

### FIELD

This disclosure generally relates to machine learning, and particularly to training generative machine learning models.

### BACKGROUND

Machine learning relates to methods and circuitry that can learn from data and make predictions based on data. In contrast to methods or circuitry that follow static program instructions, machine learning methods and circuitry can include deriving a model from example inputs (such as a training set) and then making data-driven predictions.

Machine learning is related to optimization. Some problems can be expressed in terms of minimizing a loss function on a training set, where the loss function describes the disparity between the predictions of the model being trained and observable data.

Machine learning methods are generally divided into two phases: training and inference. One common way of training certain machine learning models involves attempting to minimize a loss function over a training set of data. The loss function describes the disparity between the predictions of the model being trained and observable data. There is tremendous variety in the possible selection of loss functions, as they need not be exact—they may, for example, provide a lower bound on the disparity between prediction and observed data, which may be characterized in an infinite number of ways.

The loss function is, in most cases, intractable by definition. Accordingly, training is often the most computationally-demanding aspect of most machine learning methods, sometimes requiring days, weeks, or longer to complete even for only moderately-complex models. There is thus a desire to identify loss functions for a particular machine learning model which are less resource-intensive to compute. However, loss functions which impose looser constraints on the trained model's predictions tend to result in less-accurate models. The skilled practitioner therefore has a difficult problem to solve: identifying a low-cost, high-accuracy loss function for a particular machine learning model.

A variety of training techniques are known for certain machine learning models using continuous latent variables, but these are not easily extended to problems that require training latent models with discrete variables, such as embodiments of semi-supervised learning, binary latent attribute models, topic modeling, variational memory addressing, clustering, and/or discrete variational autoencoders. To date, techniques for training discrete latent variable models have generally been computationally expensive relative to known techniques for training continuous latent variable models (e.g., as is the case for training discrete variational autoencoders, as described in PCT application no. US2016/047627) and/or have been limited to specific architectures (e.g. by requiring categorical distributions, as in the case of Eric Jang, Shixiang Gu, and Ben Poole, Categorical reparameterization with gumbel-softmax, arXiv preprint arXiv:1611.01144, 2016).

There is thus a general desire for systems and methods for training latent machine learning models with discrete variables having general applicability, high efficiency, and/or high accuracy.

The foregoing examples of the related art and limitations related thereto are intended to be illustrative and not exclusive. Other limitations of the related art will become apparent to those of skill in the art upon a reading of the specification and a study of the drawings.

### BRIEF SUMMARY

Aspects of the present disclosure provide systems and methods for unsupervised learning over an input space comprising discrete or continuous variables. Unsupervised learning occurs over at least a subset of a training dataset of samples of the respective variables to attempt to identify the value of at least one parameter that increases the log-likelihood of the at least a subset of a training dataset with respect to a model. The model is expressible as a function of the at least one parameter. The disclosed systems comprise at least one processor and at least one nontransitory processor-readable storage medium that stores at least one of processor-executable instructions or data which, when executed by the at least one processor cause the at least one processor to execute any the disclosed methods.

Implementations of the methods involve forming a latent space comprising a plurality of random variables. The plurality of random variables comprise one or more discrete random variables and a set of supplementary continuous random variables corresponding to at least a subset of the plurality of random variables. Some implementations involve forming a first transforming distribution comprising a conditional distribution over the set of supplementary continuous random variables, conditioned on the one or more discrete random variables of the latent space. The first transforming distribution comprises a first smoothing distribution conditional on a first discrete value of the one or more discrete random variables and a second smoothing distribution conditional on a second discrete value of the one or more discrete random variables. The first and second smoothing distributions having the same support.

Some implementations involve forming an encoding distribution comprising an approximating posterior distribution over the latent space, conditioned on the input space, forming a prior distribution over the latent space, forming a decoding distribution comprising a conditional distribution over the input space conditioned on the set of supplementary continuous random variables, and training the model based on the first transforming distribution.

In some implementations, training the model based on the first transforming distribution comprises determining an ordered set of conditional cumulative distribution functions of the supplementary continuous random variables. Each cumulative distribution function comprises functions of a full distribution of at least one of the one or more discrete random variables of the latent space. Training the model further comprises determining an inversion of the ordered set of conditional cumulative distribution functions of the supplementary continuous random variables, constructing a first stochastic approximation to a lower bound on the log-likelihood of the at least a subset of a training dataset, constructing a second stochastic approximation to a gradient of the lower bound on the log-likelihood of the at least a subset of a training dataset, and increasing the lower bound on the log-likelihood of the at least a subset of a training dataset based at least in part on the gradient of the lower bound on the log-likelihood of the at least a subset of a training dataset.

In some implementations, the first and second smoothing distributions are continuous. In some implementations, the first and second smoothing distributions are symmetric. In some implementations, each of the first and second smoothing transformations is selected from the group consisting of an exponential distribution, a normal distribution, and a logistic distribution.

In some implementations, forming a first transforming distribution comprises forming a first transforming distribution based on three or more smoothing distributions. Each smoothing distribution converges to a mode of a distribution of the discrete random variables.

In some implementations, training the model comprises optimizing an objective function based on importance sampling to determine terms associated with the first transforming distribution.

In some implementations, forming a latent space comprises representing at least a portion of the latent space as a Boltzmann machine. In some implementations, training the model comprises instructing a quantum processor to physically encode a quantum distribution approximating a Boltzmann distribution, instructing the quantum processor to sample from the quantum distribution, and receiving from the quantum processor one or more samples from the quantum distribution.

In some implementations, training the model comprises optimizing an objective function having a plurality of terms and scaling each term of a subset of the plurality of terms by a corresponding scaling factor. Each scaling factor is proportional to the magnitude of its corresponding term of the objective function. In some implementations, the magnitude of the scaling factor's corresponding term was determined in a previous iteration of a parameter-update operation.

In some implementations, training the model comprises scaling each term of the subset by a common annealing factor and annealing the common annealing factor from an initial value to 1 over the course of training. In some implementations, the method further comprises removing the effect of the scaling factors when the common annealing factor reaches 1.

Aspects of the present disclosure provide a method for training a machine learning model based on an objective function having positive and negative phases, the machine learning model targeting a target model and expressible as a function at least one parameter, the method executed by circuitry including at least one processor. The method comprises forming a positive phase model based on the target model. The positive phase model comprises a first distribution. The method further comprises forming a negative phase model based on the target model. The negative phase model comprises a second distribution and the second distribution comprises a quantum distribution different than the first distribution. The method further comprises determining a positive phase term by sampling from the positive phase model, determining a negative phase term by sampling from the negative phase model, and updating the at least one parameter by evaluating the objective function based on the positive phase term and the negative phase term.

In some implementations, the first distribution is a classical approximation of the second distribution. In some implementations, the second distribution is a quantum approximation of the first distribution. In some implementations, the positive phase model comprises a classical Boltzmann machine and the negative phase model comprises a quantum Boltzmann machine corresponding to the classical Boltzmann machine. In some implementations, at least one of the positive phase term and the negative phase term comprises a gradient of a term of the objective function. In some implementations, determining a negative phase term for sampling from the negative phase model comprises causing a quantum processor to form a representation of the second distribution and sample from the representation of the second distribution.

In some implementations, each of the first distribution and the second distribution comprise quantum distributions, and the positive phase model comprises the negative phase model modified to have a higher-dimensional latent space than the negative phase model. In some implementations, sampling from the positive phase model comprises sampling from the second distribution of the negative phase model using discrete-time quantum Monte Carlo with a number of Trotter slices corresponding to the difference in dimensionality between the positive and negative phase models. In some implementations, tuning an error term between the positive and negative phase models by at least one of increasing the dimensionality of the positive phase model to reduce the error term and decreasing the dimensionality of the positive phase model to increase the error term.

Aspects of the present disclosure provide a method for training a generative machine learning model. The machine learning model comprises a quantum model and is expressible as a function at least one parameter. The method is performed by a processor and comprises instantiating a Hamiltonian of the quantum model. The Hamiltonian comprises a three- or higher-dimensional statistical system having a quantum phase transition. The method comprises tuning the Hamiltonian to occupy a state within a threshold distance of the quantum phase transition, evolving the Hamiltonian to generate a sample, and updating the at least one parameter by evaluating the objective function based on the sample.

In some implementations, the quantum phase transition comprises a finite temperature spin glass phase transition. In some implementations, the statistical system comprises a cubic lattice. In some implementations, the machine learning model comprises a quantum RBM.

In some implementations, instantiating the Hamiltonian comprises instructing a quantum processor to physically represent the Hamiltonian and evolving the Hamiltonian comprises instructing the quantum processor to evolve a state of the Hamiltonian.

Aspects of the present disclosure provide a method for training a machine learning model based on an objective function having positive and negative phases. The machine learning model is expressible as a function at least one parameter. The method is executed by circuitry including at least one processor and comprises determining a negative phase term by sampling in the negative phase. The method comprises, for each determination of a negative phase term, determining a synthesized positive phase term based on k samples in the positive phase. The method comprises updating the at least one parameter by evaluating the objective function based on the synthesized positive phase term and the negative phase term.

In some implementations, determining a synthesized positive phase term comprises determining an average of the k samples and determining the synthesized positive phase term based on the average of the k samples.

In some implementations, determining a synthesized positive phase term comprises determining k expectation terms based on the k samples and determining an average of the k expectation terms.

In some implementations, at least one of the synthesized positive phase term and the negative phase term comprises a gradient of a term of the objective function. In some implementations, determining the negative phase term comprises sampling from a quantum distribution.

In some implementations, sampling from a quantum distnbution comprises causing a quantum processor to form a representation of the quantum distribution and instructing the quantum processor to evolve to generate a sample from the representation of the quantum distribution.

In some implementations, the machine learning model comprises a quantum variational autoencoder and sampling in the negative phase comprises sampling from a prior distribution of the machine learning model.

Aspects of the present disclosure provide a method for training a generative machine learning model with discrete variables. The machine learning model is expressible as a function at least one parameter. The method is executed by circuitry including at least one processor. The method comprises forming a latent space comprising a plurality of discrete random variables defined over a GUMBEL distribution. The latent space comprises a GUMBEL-distributed Boltzmann machine defined over the discrete random variables. The method comprises forming one or more generative distributions defined over the GUMBEL-distnbuted Boltzmann machine and training the generative machine learning model.

In some implementations, the generative machine learning model comprises a discrete variational autoencoder and forming one or more generative distributions comprises forming at least a prior distribution and an approximating posterior distribution, each conditioned on the GUMBEL-distributed Boltzmann machine. In some implementations, the latent space comprises one or more additional discrete random variables hierarchically conditioned over the plurality of discrete random variables defined over the GUMBEL distribution. In some implementations, at least one of the one or more additional discrete random variables is defined over a Bernoulli distribution.

Aspects of the present disclosure provide a method for unsupervised learning over an input space comprising discrete or continuous variables, and at least a subset of a training dataset of samples of the respective variables, to attempt to identify the value of at least one parameter that increases the log-likelihood of the at least a subset of a training dataset with respect to a model. The model is expressible as a function of the at least one parameter. The method is executed by circuitry including at least one processor and comprises forming a latent space comprising a plurality of random variables. The plurality of random variables comprising one or more selectively-activatable continuous random variables and one or more binary random variables. Each binary random variable corresponds to a subset of the one or more selectable continuous random variables. Each binary random variable has on and off states. The method comprises training the model by: setting each of the one or more binary random variables to a respective ON state, determining a first updated set of the one or more parameters of the model based on each of the one or more selectively-activatable continuous random variables being active, updating the one or more parameters of the model based on the first updated set of the one or more parameters (said updating comprising setting at least one of the one or more binary random variables to a respective OFF state based on the first updated set of the one or more parameters), determining a second updated set of the one or more parameters of the model based on one or more selectively-activatable continuous random variables which correspond to binary random variables in respective ON states (said determining comprising deactivating one or more continuous random variables which correspond to binary random variables in respective OFF states), and updating the one or more parameters of the model based on the second updated set of the one or more parameters.

In some implementations, forming the latent space comprises forming a Boltzmann machine, the Boltzmann machine comprising the one or more binary random variables, and wherein training the model comprises training the Boltzmann machine.

In some implementations, training the model comprises transforming at least one of the one or more binary random variables according to a smoothing transformation and determining at least one of the first and second updated sets of the one or more parameters based on the smoothing transformation.

In some implementations, transforming at least one of the one or more binary random variables comprises transforming the at least one of the one or more binary random variables according to a spike-and-exponential transformation comprising a spike distribution and an exponential distribution.

In some implementations, the training the model comprises determining an objective function comprising a penalty based on a difference between a mean of the spike distribution and a mean of the exponential distribution.

In some implementations, determining the first updated set of parameters comprises determining the first updated set of parameters based on an approximating posterior distribution where the spike distribution is given no effect.

In some implementations, determining the first updated set of parameters comprises determining the first updated set of parameters based on a prior distribution where the spike distribution and exponential distribution have the same mean.

In some implementations, the latent space comprises one or more smoothing continuous random variables defined over the binary random variables and training the model comprises predicting each binary random variable from a corresponding one of the smoothing continuous random variables.

In some implementations, training the model comprises training at least one of an approximating posterior distribution and prior distribution based on a spectrum of exponential distributions, the spectrum of exponential distributions being a function of at least one of the smoothing continuous random variables and converging to a spike distribution for a first state of the at least one of the smoothing continuous random variables. In some implementations, training the model comprises training an L1 prior distribution. In some implementations, training an L1 prior comprises training a Laplace distribution.

Aspects of the present disclosure provide a method for unsupervised learning over an input space comprising discrete or continuous variables, and at least a subset of a training dataset of samples of the respective variables, to attempt to identify the value of at least one parameter that increases the log-likelihood of the at least a subset of a training dataset with respect to a model. The model is expressible as a function of the at least one parameter. The method is executed by circuitry including at least one processor and comprises forming a first latent space comprising a plurality of random variables. The plurality of random variables comprises one or more discrete random variables and a set of supplementary continuous random variables. The method comprises constructing a stochastic approximation to a gradient of a lower bound on the log-likelihood of at least a subset of a training dataset. The gradient is based on the one or more discrete random variables and the set of supplementary continuous random variables (said constructing comprising performing a REINFORCE variance-mitigation technique). The method comprises updating the at least one parameter based on the stochastic approximation to the gradient of the lower bound.

In some implementations, performing a REINFORCE variance-mitigation technique comprises performing a REINFORCE variance-mitigation technique selected from the group consisting of: RELAX and control variates.

Aspects of the present disclosure provide a method for training a generative machine learning model with discrete variables. The machine learning model is expressible as a function at least one parameter. The method is executed by circuitry including at least one processor and comprises forming a latent space comprising a plurality of random variables, forming an encoding distribution comprising an approximating posterior distribution over the latent space (conditioned on the input space), forming a prior distribution over the first latent space (the prior distribution comprising a quantum distribution), forming a decoding distribution comprising a conditional distribution over the input space conditioned on one or more of the plurality of random variables (the decoding distribution comprising a convolutional neural network), and training the generative machine learning model.

In some implementations, the convolutional neural network comprises a PixelCNN.

In some implementations, training the generative machine learning model comprises causing a quantum processor to sample from the quantum distribution and receiving one or more samples from the quantum processor.

Aspects of the present disclosure provide a method for training a machine learning model having a latent space comprising discrete variables. The machine learning model is expressible as a function at least one parameter. The method is executed by circuitry including at least one processor and comprises forming a latent space comprising a plurality of discrete random variables. The latent space comprises a random Markov field defined over the discrete random variables. The method comprises forming a generative model and an inference model over the random Markov field, determining at least one continuous relaxation for the plurality of discrete random variables, training the generative machine learning model based on the random Markov field, and training the inference model based on the at least one continuous relaxation.

In some implementations, the machine learning model comprises a discrete variational autoencoder. In some implementations, forming a latent space comprises instantiating a Boltzmann machine to represent a prior distribution of the discrete variational autoencoder.

In some implementations, determining the at least one continuous relaxation comprises determining at least one continuous proxy for the plurality of discrete variables, the at least one continuous proxy yielding a corresponding plurality of continuous variables. In some implementations, determining the at least one continuous proxy comprises determining the at least one continuous proxy based on a reparametrization of the plurality of discrete variables.

In some implementations, determining the at least one continuous proxy based on a reparametrization of the plurality of discrete variables comprises determining the reparametrization of the plurality of discrete variables based on the Gumbel trick.

In some implementations, determining the at least one continuous proxy comprises determining a first continuous proxy for a first one of the plurality of discrete variables and a second continuous proxy for a second one of the plurality of discrete variables, the first continuous proxy based on a first transformation of the first discrete variable's logits and the second continuous proxy based on a second transformation of the first discrete variable's logits. In some implementations, the method comprises learning the first transformation by a neural network.

In some implementations, determining the at least one continuous proxy comprises determining the at least one continuous proxy based on a partition function defined over the plurality of discrete variables.

In some implementations, determining the at least one continuous proxy comprises determining the at least one continuous proxy based on a sum of energy values for the plurality of discrete variables.

In some implementations, at least one of training the generative model and training the inference model comprises sampling from an oracle to determine a gradient of one or more objective functions over model parameters. In some implementations, sampling from an oracle comprises sampling from a quantum processor based on the random Markov field. In some implementations, sampling from a quantum processor comprises importance-weighted sampling.

In some implementations, forming the generative model and the inference model comprises forming a non-hierarchical approximating posterior distribution based on a neural network and sampling from an oracle comprises importance sampling.

In some implementations, forming a latent space comprises forming a latent space based on an RBM-structured prior distribution with sparse connectivity. In some implementations, forming a latent space with sparse connectivity comprises forming a latent space over a Chimera architecture.

Aspects of the present disclosure provide a method for training a machine learning model having a latent space comprising discrete variables. The machine learning model is expressible as a function at least one parameter. The method is executed by circuitry including at least one processor and comprises forming a latent space comprising a plurality of discrete random variables, forming at least one model distribution based on the latent space, receiving one or more samples from an oracle based on the at least one model distribution, determining a first value of a first term of an importance-weighted objective function of the machine learning model based on a plurality of samples and the at least one parameter, determining a second value of a second term of the importance-weighted objective function of the machine learning model analytically based on the at least one parameter, synthesizing an objective value for the objective function based on the first and second values, and updating the at least one parameter based on the objective value.

In some implementations, the machine learning model comprises a discrete variational autoencoder and forming at least one model distribution comprises forming a prior distribution and decoding distribution.

In some implementations, the first term comprises a partition term describing a partition function of the prior distribution and determining the first value comprises determining an expectation of the partition term based on the one or more samples.

In some implementations, the second term comprises an energy term describing an energy of the prior distribution and determining the second value comprises determining a weighted expectation of the energy term analytically.

In some implementations, synthesizing an objective value for the objective function comprises synthesizing a first gradient of the objective function relative to a first subset of the at least one model parameter based on the first and second values and determining a second gradient of the objective function relative to a second subset of the at least one model parameter analytically.

In some implementations, the method comprises reparametrizing the plurality of discrete variables based on the Heaviside function, wherein determining a second value of a second term of the importance-weighted objective function comprises determining a gradient of the objective function with respect to one or more parameters of the at least one parameter based on a derivative of the Heaviside function, the one or more parameters relating to the decoding distribution.

### BRIEF DESCRIPTION OF THE SEVERAL VIEWS OF THE DRAWING(S)

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is a schematic diagram of an exemplary hybrid computer including a digital computer and an analog computer in accordance with the present systems, devices, methods, and articles.

FIG. 2A is a schematic diagram illustrating an example implementation of a generative machine learning model with a discrete-variable latent space.

FIG. 2B is a schematic diagram illustrating an example implementation of an inference machine learning model corresponding to the model of FIG. 2A.

FIG. 2C is a schematic diagram illustrating an example implementation of the generative machine learning model of FIG. 2A adapted by hiding the discrete variables with continuous variables.

FIG. 2D is a schematic diagram illustrating an example implementation of an inference machine learning model corresponding to the model of FIG. 2C.

FIG. 2E is a schematic diagram illustrating an example implementation of the generative machine learning model of FIG. 2A adapted by relaxing the discrete variables into continuous variables.

FIG. 2F is a schematic diagram illustrating an example implementation of an inference machine learning model corresponding to the model of FIG. 2E.

FIG. 2G is a schematic diagram illustrating an example implementation of the generative machine learning model of FIG. 2C adapted by implementing the latent space as a Boltzmann machine.

FIG. 2H is a schematic diagram illustrating an example implementation of an inference machine learning model corresponding to the model of FIG. 2G.

FIG. 3 is a graph of an example smoothing distribution produced by overlapping smoothing transformations.

FIG. 4A is a schematic illustration of an example implementation of a generative machine learning model with a convolutional hidden layer of variables.

FIG. 4B is a schematic diagram illustrating an example implementation of an inference machine learning model corresponding to the model of FIG. 4A.

FIG. 5A is a schematic diagram of an example implementation of an approximating posterior distribution of an example discrete variational autoencoder.

FIG. 5B is a schematic diagram of an example implementation of a prior distribution of the example discrete variational autoencoder of FIG. 5A.

FIG. 5C is a schematic diagram of an example implementation of a decoding distribution of the example discrete variational autoencoder of FIG. 5A.

FIG. 6 is a flowchart of an example method for unsupervised learning using smoothing transformations as described herein.

FIG. 7 is a flowchart of an example method for training an example machine learning model with mixed models.

FIG. 8 is a flowchart of an example method for training an example machine learning model using quantum phase transitions.

FIG. 9 is a flowchart of an example method for expedited training of an example quantum machine learning model.

FIG. 10A is a schematic diagram illustrating an example implementation of a generative machine learning model with a discrete-variable latent space according to a continuous relaxation described herein.

FIG. 10B is a schematic diagram illustrating an example implementation of an inference machine learning model corresponding to the model of FIG. 10A according to a continuous relaxation described herein.

FIG. 10C is a flowchart of an example method for training an example continuously-relaxed discrete variational autoencoder.

FIG. 11 is a flowchart of an example method for training an example generative machine learning model based on graph-representable inputs.

FIG. 12 is a flowchart of an example method for training an example VAE to induce sparsity with binary variables.

FIG. 13 is a flowchart of an example method for training a VAE based on REINFORCE variance-mitigation techniques.

FIG. 14 is a flowchart of an example method for training a VAE with a quantum prior and a convolutional neural network decoder.

FIG. 15 is a flowchart of an example method for training a machine learning model having a latent space comprising discrete variables using importance-weighted sampling.

FIG. 16 is a flowchart of an example method for training a machine learning model which integrates plurality of layered distributions.

FIG. 17 is a flowchart of an example method for relaxing an example Boltzmann machine-based DVAE.

FIG. 18 is a flowchart of an example method for training a machine learning model based on mean-field estimation.

FIG. 19 is a flowchart of an example method for adapting a machine learning model to a sparse underlying connectivity graph (e.g. the topology of an analog processor).

### DETAILED DESCRIPTION

The present disclosure provides novel architectures for machine learning models having latent variables, and particularly to systems instantiating such architectures and methods for training and inference therewith. We provide a new approach to converting binary latent variables to continuous latent variables via a new class of smoothing transformations. In the case of binary variables, this class of transformation comprises two distributions with an overlapping support that in the limit converge to two Dirac delta distributions centered at 0 and 1 (e.g., similar to a Bemoulli distribution). Examples of such smoothing transformations include a mixture of exponential distributions and a mixture of logistic distributions. The overlapping transformation described herein can be used for training a broad range of machine learning models, including directed latent models with binary variables and latent models with undirected graphical models in their prior. These transformations are associated with novel approaches to training, including a new importance-sampling-based implementation of a variational lower bound that can be efficiently trained without necessarily requiring special treatment of gradients.

### Introductory Generalities

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with computer systems, server computers, and/or communications networks have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the implementations.

### Computing Systems

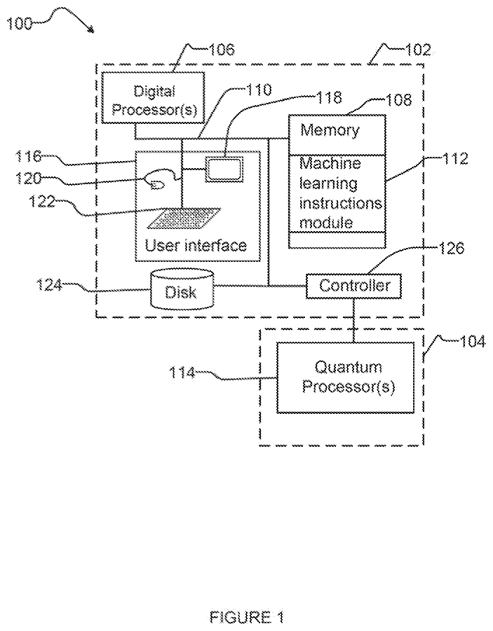

FIG. 1 illustrates a computing system 100 comprising a digital computer 102. The example digital computer 102 includes one or more digital processors 106 that may be used to perform classical digital processing tasks. Digital computer 102 may further include at least one system memory 108, and at least one system bus 110 that couples various system components, including system memory 108 to digital processor(s) 106. System memory 108 may store a VAE instructions module 112.

The digital processor(s) 106 may be any logic processing unit or circuitry (e.g., integrated circuits), such as one or more central processing units (“CPUs”), graphics processing units (“GPUs”), digital signal processors (“DSPs”), application-specific integrated circuits (“ASICs”), programmable gate arrays (“FPGAs”), programmable logic controllers (“PLCs”), etc., and/or combinations of the same.

In some implementations, computing system 100 comprises an analog computer 104, which may include one or more quantum processors 114. Digital computer 102 may communicate with analog computer 104 via, for instance, a controller 126. Certain computations may be performed by analog computer 104 at the instruction of digital computer 102, as described in greater detail herein.

Digital computer 102 may include a user input/output subsystem 116. In some implementations, the user input/output subsystem includes one or more user input/output components such as a display 118, mouse 120, and/or keyboard 122.

System bus 110 can employ any known bus structures or architectures, including a memory bus with a memory controller, a peripheral bus, and a local bus. System memory 108 may include non-volatile memory, such as read-only memory (“ROM”), static random access memory (“SRAM”). Flash NAND; and volatile memory such as random access memory (“RAM”) (not shown).

Digital computer 102 may also include other non-transitory computer- or processor-readable storage media or non-volatile memory 124. Non-volatile memory 124 may take a variety of forms, including: a hard disk drive for reading from and writing to a hard disk (e.g., magnetic disk), an optical disk drive for reading from and writing to removable optical disks, and/or a solid state drive (SSD) for reading from and writing to solid state media (e.g., NAND-based Flash memory). The optical disk can be a CD-ROM or DVD, while the magnetic disk can be a rigid spinning magnetic disk or a magnetic floppy disk or diskette. Non-volatile memory 124 may communicate with digital processor(s) via system bus 110 and may include appropriate interfaces or controllers 126 coupled to system bus 110. Non-volatile memory 124 may serve as long-term storage for processor- or computer-readable instructions, data structures, or other data (sometimes called program modules) for digital computer 102.

Although digital computer 102 has been described as employing hard disks, optical disks and/or solid state storage media, those skilled in the relevant art will appreciate that other types of nontransitory and non-volatile computer-readable media may be employed, such magnetic cassettes, flash memory cards, Flash, ROMs, smart cards, etc. Those skilled in the relevant art will appreciate that some computer architectures employ nontransitory volatile memory and nontransitory non-volatile memory. For example, data in volatile memory can be cached to non-volatile memory. Or a solid-state disk that employs integrated circuits to provide non-volatile memory.

Various processor- or computer-readable instructions, data structures, or other data can be stored in system memory 108. For example, system memory 108 may store instruction for communicating with remote clients and scheduling use of resources including resources on the digital computer 102 and analog computer 104. Also for example, system memory 108 may store at least one of processor executable instructions or data that, when executed by at least one processor, causes the at least one processor to execute the various algorithms described elsewhere herein, including machine learning related algorithms. For instance, system memory 108 may store a machine learning instructions module 112 that includes processor- or computer-readable instructions to provide a machine learning model, such as a variational autoencoder. Such provision may comprise training and/or performing inference with the machine learning model, e.g., as described in greater detail herein.

In some implementations system memory 108 may store processor- or computer-readable calculation instructions and/or data to perform pre-processing, co-processing, and post-processing to analog computer 104. System memory 108 may store a set of analog computer interface instructions to interact with analog computer 104. When executed, the stored instructions and/or data cause the system to operate as a special purpose machine.

Analog computer 104 may include at least one analog processor such as quantum processor 114. Analog computer 104 can be provided in an isolated environment, for example, in an isolated environment that shields the internal elements of the quantum computer from heat, magnetic field, and other external noise (not shown). The isolated environment may include a refrigerator, for instance a dilution refrigerator, operable to cryogenically cool the analog processor, for example to temperature below approximately 1 Kelvin.

### Variational Autoencoders

The present disclosure has applications in a variety of machine learning models. As an example, we will refer frequently to variational autoencoders (“VAEs”), and particularly to discrete variational autoencoders (“DVAEs”). A brief review of DVAEs is provided below; a more extensive description can be found in PCT application no. US2016/047627.

A VAE is a generative model that defines a joint distribution over a set of observed random variables x and a set of latent variables z. The generative model may be defined by p(x, z)=p(z)·p(x|z) where p(z) is a prior distribution and p(x|z) is a probabilistic decoder. Given a dataset X={x⁽¹⁾, . . . , x^{N}}, the parameters of the model may be trained by maximizing the log-likelihood:

$$log p ( X ) = {\sum }_{i = 1}^{N} log p ( {x}^{( i )} ) .$$

Typically, computing log p(x) requires an intractable marginalization over the latent variables z. To address this problem, a VAE introduces an inference model or probabilistic encoder q(z|x) that infers latent variables for each observed instance. Typically, instead of maximizing the marginal log-likelihood, a VAE will maximize a variational lower bound (also called an evidence lower bound, or ELBO), usually in the following general form:

log p(x)≥ [symbol] _{q(z|x)}[log p(x|z)]−KL[q(z|x)∥p(z)].

The gradient of this objective may be computed for the parameters of both the encoder and decoder using a technique referred to as “reparameterization” (and sometimes as the “reparametrization trick”). With reparametrization, the expectation with respect to q(z|x) in the ELBO is replaced with an expectation with respect to a known optimization-parameter-independent base distribution and a differentiable transformation from the base distribution to q(z|x). For instance, in the case of a Gaussian base distribution, the transformation may be a scale-shift transformation. As another example, the transformation may rely on the inverse cumulative distribution function (CDF). During training, the gradient of the ELBO is estimated using samples from the base distribution.

Unfortunately, the reparameterization trick cannot be applied directly to discrete latent variables because there is no known differentiable transformation that maps a base distribution to a suitable discrete distribution. This may be addressed by, for example, continuously relaxing the discrete latent variables and/or hiding the discrete variables behind continuous variables. An example of continuous relaxation in the case of a discrete variable with a categorical distribution is adding additive Gumbel noise and a softmax transformation with a defined temperature to the discrete variable, yielding a continuous random variable with a distribution which converges to the original categorical distribution as temperature approaches zero. An example of hiding discrete variables is pairing each discrete variable with an auxiliary continuous random variable and then marginalizing out the discrete variable to yield a marginal distribution over the continuous auxiliary variables. The reparameterization trick may be applied to the distribution of the resulting continuous variable.

For instance, PCT application no. US2016/047627 describes a hiding approach where a binary random variable z with probability mass function q(z|x) is transformed using a spike-and-exponential transformation r(ζ|z) where r(ζ|z=0)=δ(ζ) is a Dirac delta distribution (i.e. the “spike”) and r(ζ|z=1)∝exp(βζ) is an exponential distribution defined for ζ∈[0,1] with inverse temperature P controlling the sharpness of the distribution. The marginal distribution q(ζ|x) is a mixture of two continuous distributions. By factoring the inference model of the DVAE so that x depends on ζ rather than z, the discrete variables can be eliminated from the ELBO (effectively “hidden” behind continuous variables ζ) and reparametrization can be applied.

A challenge that arises here is that the Dirac delta distribution can be challenging to train with certain gradient-based approaches, but alternative transformations require their own reparametrizations and implementations of the ELBO and/or (D)VAE architecture which are non-trivial (and indeed often very challenging) to design.

### Overlapping Transformations

Some implementations of the present disclosure provide a broader range of available smoothing transformations of binary variables (e.g., which do not require the use of the Dirac delta function). A smoothing transformation can be defined using one or more smoothing distributions. For instance, an example smoothing transformation r can be defined using two exponential (e.g., Laplace) distributions as follows:

$$r ( ζ \vert z = 0 ) = \frac{{e}^{- β ζ}}{{Z}_{β}} and r ( ζ \vert z = 1 ) = \frac{{e}^{β ( ζ - 1 )}}{{Z}_{β}}$$

for ζ∈[0,1] where P is an inverse temperature parameter and Z_{β}=(1−e^{-β})/β is the normalizing constant.

Graph 300 of FIG. 3 shows the smoothing distributions r(ζ|z=0) and r(ζ|z=1) produced by the smoothing transformation r conditional on the corresponding value of z. Curve 302 corresponds to r(ζ|z=0) and curve 304 corresponds to r(ζ|z=1). Axis 310 describes the continuous variable (and axis 312 describes the value of the smoothing transform z as a function of ζ, i.e. r(ζ|z) for a given value of z.

Smoothing transformation r may be used to define a mixture distribution q(ζ|x)=Σ_{z}q(z|x)r(ζ|z) which marginalizes out the discrete distribution q(z|x) (which may be, for example, a Bernoulli distribution). For the example smoothing transformation given above, q(ζ|z) approaches q(z=0|x)δ(ζ)+q(z=1|x)δ(ζ−1) as β→∞.

Applying the reparameterization trick for mixture distribution q(ζ|x) requires the inverse CDF of mixture distribution q(ζ|x). One of the challenges of defining smoothing transformations r based on multiple continuous distributions and defining the mixture distribution q(ζ|x) thereon is that the inverse CDF can be difficult to derive and may not be suitable for efficient training. For the example smoothing transformation given above, the inverse CDF is described by:

$${F}_{q ( ζ \vert x )}^{- 1} ( ρ ) = - \frac{1}{β} log \frac{- b + \sqrt{{b}^{2} - 4 c}}{2}$$

where b=[ρ+e^{-β}(q−φ]/(1−q)−1 and c=−[q e^{-β}]/(1−q). This is a differentiable function that converts a sample ρ from the uniform distribution [symbol] (0,1) to a sample from q(ζ|x). It approaches a step function as β→∞, although to benefit from gradient information during training it can be beneficial to set β to a finite value.

The present disclosure is not limited to mixtures of exponential distributions. Indeed, if the distributions being mixed have the same support (i.e. if they are completely overlapping) then arbitrary smoothing transformations can be used. This is because in such circumstances the cross entropy term of the ELBO (sometimes expressed [symbol] _{q(z|x)}[Wᵢⱼzᵢzⱼ]) can be expressed as:

$${𝔼}_{q ( Z , X )} [ {W}_{ij} {z}_{i} {z}_{j} ] = {W}_{ij} {𝔼}_{ρ k < j} [ \frac{r ( {ζ}_{i} \vert {z}_{i} = 1 ) q ( {z}_{i} = 1 \vert {ζ}_{k < i} , x )}{{Σ}_{{z}_{i}} r ( {ζ}_{i} \vert {z}_{i} ) q ( {z}_{i} \vert {ζ}_{k < i} , x )} q ( {z}_{ij} = 1 \vert {ζ}_{k < j} , x ) ]$$

This expression applies reparametrization in a general way without depending on the specific form of r(ζ|zᵢ=0) or r(ζᵢ|zᵢ=1), except that they must have the same support. This produces a resulting mapping from random variable ρᵢ to ζᵢ given by ζᵢ=F_{q(ζ}_{ᵢ}_{|x)}⁻¹(ρᵢ). Significantly, this function lacks discontinuous variables and is trainable analytically by common gradient descent techniques.

In the case of binary discrete random variables, any pair of overlapping smoothing distributions converging to δ(ζ) and δ(ζ−1) can be used. A larger number of overlapping smoothing distributions may be used in the case of non-binary discrete variables such that the mixture of distributions converges to point-probability-mass modes of the discrete distribution from which the discrete variables are drawn.

Suitability of a smoothing distribution will vary according to the inverse CDF of their mixture distribution. For example, normal or logistic distributions may be used. In some implementations, the smoothing distributions are continuous. In some implementations, they are symmetric (e.g. as in the above example of a mixture of exponentials). Various example implementations of smoothing and mixture distributions are described below.

A smoothing transformation can be defined by modelling r(ζ|z) using normal distributions with means shifted relative to the z value. For instance, the following smoothing transformation may be used:

r(ζ|z=0)= [symbol] (ζ;0,σ²)

r(ζ|z=1)= [symbol] (ζ;1,σ²)

In this case, the resulting mixture q(ζ)=Σ_{z}r(ζ|z)q(z) will converge to a Bernoulli distribution as σ→0. However, a challenge with this approach is that the CDF resulting from q(ζ) cannot be inverted analytically. This may be addressed, for example, by approximating the normal distributions (e.g. with logistic distributions) to obtain an analytically-invertible CDF and/or by determining the gradient of the samples with respect to the probability of a binary state under the mixture distribution; both approaches are described in greater detail below.

In some embodiments, the smoothing transformation may be an approximation of a desired smoothing transformation; for example, where normally-distributed smoothing transformations are desired (e.g. as shown above) the smoothing transformations may be defined by logistic distributions. A potential advantage of this approach is that the distribution approximates what would be obtained by the use of normal distributions, but allows for an analytically-invertible CDF. The smoothing transformation may, for example, be defined as follows:

$$r ( ζ \vert z = 0 ) = ℒ ( ζ ; {μ}_{0} , s )$$

$$r ( ζ \vert z = 1 ) = ℒ ( ζ ; {μ}_{1} , s )$$

$$where$$

$$L ( ζ ; u , s ) = \frac{{e}^{\frac{ζ - μ}{s}}}{{s ( 1 + {e}^{\frac{ζ - μ}{s}} )}^{2}} .$$

The mixture distribution may then be defined by:

q(ζ)=(1−q) [symbol] (ζ,μ₀,s)+q [symbol] (ζ,μ₁,s)

and the inverse CDF can be determined by solving:

$${F}_{q ( ζ )} ( ζ ) = \frac{1 - q}{1 + {e}^{- \frac{ζ - {μ}_{0}}{s}}} + \frac{q}{1 + {e}^{- \frac{ζ - {μ}_{1}}{s}}} = ρ$$

$$\frac{( 1 - q ) ( 1 + {e}^{- \frac{( ζ - {μ}_{1} )}{s}} ) + q ( 1 + {e}^{- \frac{ζ - {μ}_{0}}{s}} )}{( 1 + {e}^{- \frac{ζ - {μ}_{1}}{s}} ) ( 1 + {e}^{- \frac{ζ - {μ}_{0}}{s}} )} = ρ$$

If we define

$$m = {e}^{- \frac{ζ}{s}} , {d}_{0} = {e}^{\frac{{μ}_{0}}{s}} ,$$

and

$${d}_{1} = {e}^{\frac{{μ}_{1}}{s}}$$

then we can derive a solution m* for m, namely:

$${m}^{*} = \frac{- b + \sqrt{{b}^{2} - 4 ac}}{2 a}$$

where a=ρd₀d₁, b=ρ(d₀+d₁)−d₀q−d₁(1−q), and c=ρ−1.

This yields the inverse CDF F_{q(ζ)}⁻¹(φ=−s log m⁺. When s is very small and μ₁>μ₀, d₁ is susceptible to overflow; a numerically stable solution can be obtained by, for example, applying the change of variable m′=\sqrt{d₀d₁}m.

Although it may be convenient, in some circumstances, to define a smoothing transformation which yields a mixture distribution with an analytically-determinable and explicitly-identified inverse CDF, it is possible to reparametrize overlapping transformations without explicitly determining the inverse CDF analytically. This allows for an even broader range of smoothing transformations to be used.

Given an overlapping smoothing transformation r(ζ|z) with a known probability density function (PDF) and CDF, we can define the corresponding mixture distribution q(ζ|x) based on the values of the smoothing distribution given each binary value and the probability under the mixture distribution that the binary state is 1 (or, without loss of generality, 0) for a given input, expressible as q=q(z=1|x). For instance, the mixture distribution for a smoothing transformation defined for one-dimensional z and ζ may be based on:

q(ζ|x)=(1−q)r(ζ|z=0)+qr(ζ|z=1)

which is a special case of the more general form q(ζ|x)=Σ_{z} q(z|x)r(ζ|z).

We can sample from q(ζ|x) by ancestral sampling (i.e. by first sampling from the binary distribution q(z|x) and then from the conditional distribution r(ζ|z)), but the result is not differentiable with respect to q.

We can determine the gradient of the samples from q(ζ|x) with respect to q based on the PDF and CDF for the smoothing distribution. For example, for the example mixture distribution q(ζ|x) given above, we can note that its inverse CDF F_{q(ζ|x)}⁻¹ is obtainable based on:

F_{q(ζ|x)}⁻¹)(ζ)=(1−q)R(ζ|z=0)+qR(ζ|z=1)=ρ

where ρ∈[0,1] and R(ζ|z) is the CDF for r(ζ|z). The gradient of the samples with respect to q may be determined based on the gradient of the inverse CDF of q(ζ|x), e.g. as follows:

$$\frac{\partial ζ}{\partial q} = \frac{R ( ζ \vert z = 0 ) - R ( ζ \vert z = 1 )}{( 1 - q ) r ( ζ \vert z = 0 ) + qr ( ζ \vert z = 1 )}$$

which can be determined based on the PDF and CDF for r(ζ|z), without explicitly determining the values of the CDF (or inverse CDF) for q(ζ|x).

This construction allows for the definition of a range of overlapping transformations without requiring that the corresponding mixture distribution have an explicitly defined (or even analytically-determinable) CDF.

Note that if the smoothing transformation r is defined over another domain (e.g., over z and a temperature parameter β) then it may be necessary to determine the gradient of ζ with respect to additional parameters, which may involve determining the gradient of the smoothing transformation's CDF with respect to the additional parameters. For example, if r is defined over z and β then the gradient of ζ with respect to β may be determined on:

$$\frac{\partial ζ}{\partial β} = \frac{( 1 - q ) \frac{\partial R ( ζ \vert z = 0 )}{\partial β} - q \frac{\partial R ( ζ \vert z = 1 )}{\partial β}}{( 1 - q ) r ( ζ \vert z = 0 ) + qr ( ζ \vert z = 1 )} .$$

The above-described smoothing transformations can be applied to training of machine learning models with discrete latent variables, such as discrete variational autoencoders.

### Adapting Graphical Models to Use Smoothing Transformations

Generative models are commonly designed as graphical models, such a directed or undirected graphical models. PCT application no. US2016/047627 discloses methods for adapting undirected graphical models to accommodate continuous transformations of discrete variables which are also applicable here. However, it is also possible to adapt directed graphical models to accommodate the present continuous transformations.

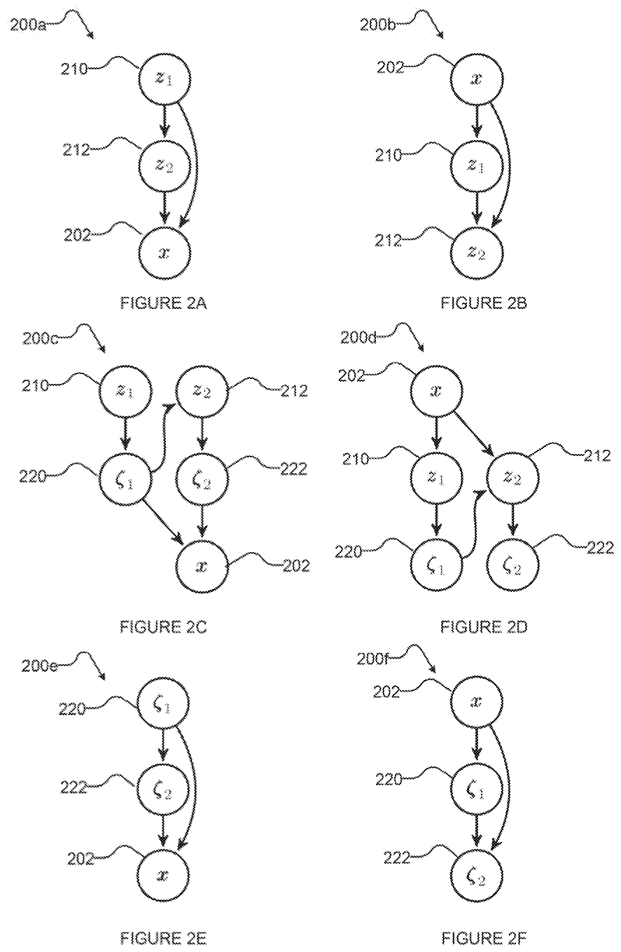

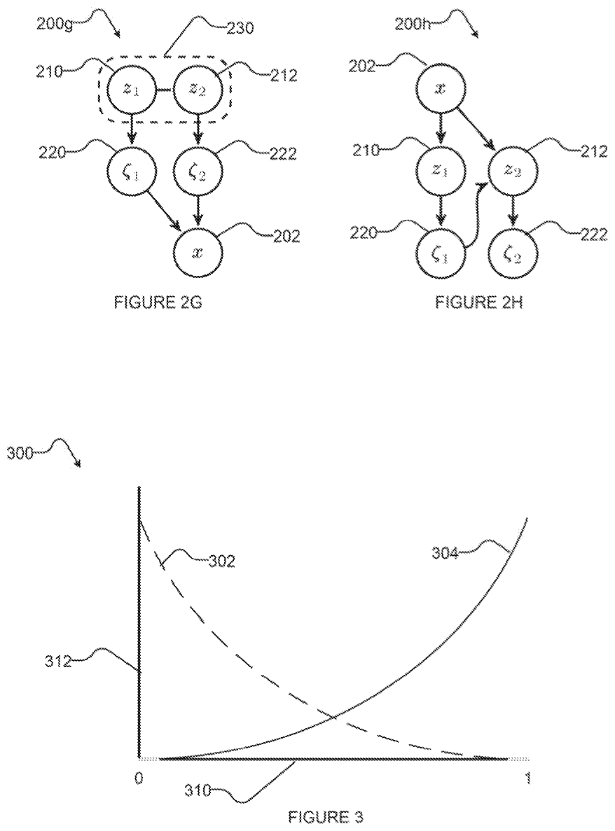

FIG. 2A shows an example generative model 200a with binary latent variables 210 (z₁) and 212 (z₂). FIG. 2B shows a corresponding inference model 200b. Data 202 (x) is either an input (as in inference model 200b) or an output (as in generative model 200a). In the example model, latent variable 212 depends on latent variable 210.

To train models 200a and 200b using smoothing transformations, the models may be adapted to introduce continuous variables 220 (ζ₁) and 222 (ζ₂), as shown in FIGS. 2C-2H. FIGS. 2C and 2D show an example of “hiding” discrete variables 210, 212 behind continuous variables 220, 222 to produce a joint model. The dependencies of discrete variables 210, 212 are transferred to the corresponding continuous variables 220, 222 and continuous variables 220, 222 are made dependent on their corresponding discrete variables.

Thus, in adapted generative model 200c of FIG. 2C, data 202 becomes dependent on continuous variables 210 and 222 and discrete variable 212 becomes dependent on continuous variable 220 in place of discrete variable 210. Antecedents are not necessarily changed, however, as shown (for example) in adapted inference model 200d of FIG. 2D, where discrete variables 210, 212 remain dependent on data 202.

Whether or not a relation is adjusted in the directed graphical model depends on the direction of the relation—dependencies of discrete variables are adjusted to be dependencies of continuous variables, but those discrete variables continue to be dependencies of other variables (except to the extent that those other variables are themselves hidden behind continuous variables). In this way, binary latent variables influence other variables only through their continuous counterparts.

If the model distribution p, approximating posterior q, and mixing distribution r are for models 200c, 200d are factorial then the ELBO for models 200c and 200d can be given by:

[symbol]

_{q(ζ}_{₁}_{|x)}[ [symbol] _{q(ζ}_{₂}_{|x,ζ}_{₁}₎[log p(x|ζ₁,ζ₂)]]−KL(q(z₁|x)∥p(z₁))− [symbol] _{q(ζ}_{₁}_{|x)}[KL(q(z₂|x,ζ₁)∥p(z₂|ζ₁))]

The KL terms of the above ELBO corresponding to the divergence between factorial Bernoulli distributions have a closed form. The expectation over ζ₁ and ζ₂ may be reparametrized as described above, allowing for the ELBO to be used by (for example) gradient descent training techniques.

FIGS. 2E and 2F shows an example of “relaxing” discrete variables 210, 212 into continuous variables 220, 222 to produce a marginal model. In this case, discrete variables 210, 212 are substituted with continuous variables 220, 222, which have the same relations with other variables as the discrete variables 210, 212 did (modulo any substitutions). Such models 220e, 200f can be produced by, for example, generating models 200c, 200d via hiding and then marginalizing out the discrete variables. The ELBO for models 200e, 200f can be given by:

[symbol]

_{q(ζ}_{₁}_{|x)}[ [symbol] _{q(ζ}_{₂}_{|x,ζ}_{₁}₎[log p(x|ζ₁,ζ₂)]]−KL(q(ζ₁|x)∥p(ζ₁))− [symbol] _{q(ζ}_{₁}_{|x)}[KL(q(ζ₂|x,ζ₁)∥p(ζ₂|ζ₁))]

where p(ζ₁)=Πᵢr(ζ_{1,i}|zᵢ)p(zᵢ) and p(ζ₂|ζ₁)=Πᵢr(ζ_{2,i}|ζ_{1,i}) with p(ζ_{2,i}|ζ_{1,i})=Σ_{z}_{_{2,i}}r(ζ_{2,i}|z_{2,i})p(z_{2,i}|ζ_{1,i}). The KL terms of this ELBO do not have a closed form but can be estimated, e.g. by Monte Carlo techniques. However, the ELBO of this marginal graphical model provides a tighter bound than the ELBO of the above-described joint model, so in suitable circumstances it may be advantageous to use a marginal graphical model as described above.

### Adapting Boltzmann Machine-Based Models

In some implementations, the prior distribution of the machine learning model is defined using a Boltzmann machine (which includes, for example, restricted Boltzmann machines, or “RBMs”). PCT application no. US2016/047627 discloses certain exemplary approaches to using Boltzmann machines. The smoothing transformations described above can be applied in this context to, for example, enable the development of machine learning models which are trainable with low-variance gradient estimates even when defined over an RBM.

FIGS. 2G and 2F show a generative model 200g and an inference model 200f, respectively, where the generative model 200g comprises a Boltzmann machine 230. A Boltzmann machine defines a probability distribution over binary random variables arranged on a graph. In a restricted Boltzmann machine, the graph is bipartite. In some implementations, such as an example RBM implementation, the probability distribution takes the form p(z₁, z₂)=e^{-E(z}^{₁}^{,z}^{₂}⁾/Z where E(z₁, z₂)=−a₁^{T}z₁−a₂^{T}z₂−z₁^{T}Wz₂ is an energy function with linear biases a₁ and a₂, pairwise interactions W capture statistical dependencies between z₁ and z₂, and Z is the partition function.

As described above with reference to FIGS. 2C and 2D, in some implementations discrete variables 210, 212 are hidden behind continuous variables 220, 222 and conditionals are formed on the continuous variables (instead of the binary variables z. The corresponding inference model can be constructed in any suitable way; the example inference model of FIG. 2H is constructed in the same way as inference model 200d of FIG. 2D, namely in a hierarchical structure that infers both z and ζ.

The ELBO for the machine learning model comprising models 200g and 200h may will be similar to the ELBO of the joint model comprising models 200c and 200d (due to the similar structure), although the first term will be different due to the use of a Boltzmann machine in the prior.

Computing a KL term with a Boltzmann machine prior is likely to be more challenging the computing the corresponding term of the model 200c ELBO. The following disclosure presents a novel training approach to ameliorate at least some of this challenge in certain circumstances. Significantly, it can enable the use of commonly-applied gradient-based processing techniques in the training of discrete variational autoencoders with Boltzmann machine priors.

The KL contribution to the ELBO for a discrete variational autoencoder structured according to models 200g and 200h can be approximated using importance sampling. This yields the following estimation of the KL contribution to the ELBO:

$$KL ( q ( {z}_{1} , {z}_{2} , {ζ}_{1} , {ζ}_{2} \vert x ) \vert p ( {z}_{1} , {z}_{2} , {ζ}_{1} , {ζ}_{2} ) ) = - H ( q ( {z}_{1} \vert x ) ) - {𝔼}_{q ( {ζ}_{1} \vert x )} [ H ( q ( {z}_{2} \vert x , {ζ}_{1} ) ) ] - {a}_{1}^{T} {μ}_{1} ( x ) - {𝔼}_{q ( {ζ}_{1} \vert x )} [ {a}_{2}^{T} {μ}_{2} ( x , {ζ}_{1} ) ] - {𝔼}_{q ( {ζ}_{1} \vert x )} [ {σ ( {g}_{1} ( x ) + ω ( {ζ}_{1} ) )}^{T} W {μ}_{2} ( x , {ζ}_{1} ) ] + log Z .$$

In this expression H(q) is the entropy of the distribution q. This has a closed form for certain distributions q, including the Bernoulli distribution. The notation μ₁ and μ₂ is introduced for convenience; μ₁(x)≡{q(z_{1,i}=1|x)∀i} and μ₁(x,ζ₁)≡{q(z_{2,i}=1|x, ζ₁)∀i}. Further, σ(x)=1/(1+e^{-x}) is the logistic function, and g₁(x)≡log[μ₁(x)/(1−μ₁(x))] is the logit function applied to μ₁(x). Applying an importance-weighted approximation to the log likelihood ratio yields an estimation of ω(ζ)≡log[r(ζ|z=1)r(ζ|z=0)], which can be expressed analytically as ω(ζ)=β(2ζ−1) when a mixture of exponential smoothing transformations is used.

Conveniently, all terms contributing to the KL term other than log Z can be computed analytically given samples from a hierarchical encoder. Expectations with respect to q(ζ₁|x) can be reparameterized using the inverse CDF function. It is then convenient to back-propagate the gradients through the network using common gradient-based techniques, with only the log Z term requiring special treatment. This pleasing property is a result of r(ζ|z) having the same support for both z=0 and z=1.

It is further possible to include log Z in the objective function to enable that term to be determined conveniently without undue burden to the implementer. For training a DVAE model with an RBM prior, the gradient of log Z can be computed in each parameter update based on the prior parameters θ={a₁, a₂, W}. Its gradient may be determined with respect to θ without necessarily requiring any other inputs. For example, in some implementations its gradient can be determined based on the following:

$$\frac{\partial log Z}{\partial θ} = \frac{\partial }{\partial θ} log {\sum }_{{z}_{1} , {z}_{2}} {e}^{- {E}_{θ} ( {z}_{1} , {z}_{2} )} = - \frac{{\sum }_{{z}_{1} , {z}_{2}} {e}^{- {E}_{θ} ( {z}_{1} , {z}_{2} )} \frac{\partial {E}_{θ} ( {z}_{1} , {z}_{2} )}{\partial θ}}{{\sum }_{{z}_{1}^{′} , {z}_{2}^{′}} {e}^{- {E}_{θ} ( {z}_{1}^{′} , {z}_{2}^{′} )}} = - {\sum }_{{z}_{1} , {z}_{2}} {p}_{θ} ( {z}_{1} , {z}_{2} ) \frac{\partial {E}_{θ} ( {z}_{1} , {z}_{2} )}{\partial θ} = - {𝔼}_{{p}_{θ} ( {z}_{1} , {z}_{2} )} [ \frac{\partial {E}_{θ} ( {z}_{1} , {z}_{2} )}{\partial θ} ]$$

That is, the gradient of the log partition function is equal to the expected gradient of the energy with respect to the model parameters (known as negative phase). This expectation is can be estimated using Monte Carlo samples from the model. In some implementations, determining this expectation comprises performing persistent contrastive divergence, e.g., maintaining persistence chains and running Gibbs sampling updates for a fixed number of iterations to update the samples after each parameter update.

In some implementations, the implementer can avoid manually computing the gradient of the negative energy function for each sample and modifying the gradient of whole objective function by computing the negative average energy on the samples generated from PCD chains

$$( e . g . - \frac{1}{L} {\sum }_{l} {E}_{θ} ( {z}_{1}^{( l )} , {z}_{2}^{( l )} )$$

where z₁^{(l)}, z₂^{(l)}˜p_{θ}(z₁, z₂) and L is the total number of samples). This results in a scalar tensor with a gradient equal to the gradient of the log partition function. The Monte Carlo estimate of the gradient of the log Z term may thus be incorporated into training simply by adding this tensor to the objective function and performing backpropagation in the usual way.

### Adapted Discrete Variational Autoencoders

The foregoing description provides generalized examples of smoothing transformations being applied in the architecture and training of discrete latent variable machine learning models. It is possible to build much more sophisticated models using the present techniques. One such example model is provided herein—an improved discrete variational autoencoder.

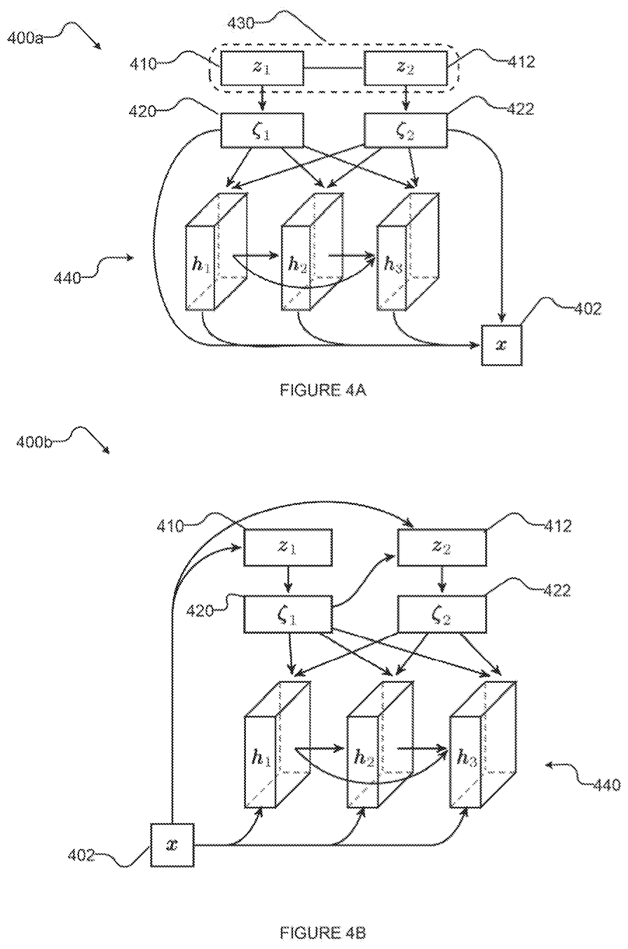

An example DVAE is shown in FIGS. 4A and 4B, which illustrate a generative model 400a and an inference model 400b, respectively, having discrete (or “global”) variables 410, 412, continuous variables 420, 422, and hidden (or “local”) variables 440. Hidden variables 440 may also be continuous; to disambiguate, continuous variables 420 may be referred to as “auxiliary” variables. Hidden variables 440 may be multi-layered (e.g., convolutional) and thus are shown as three-dimensional volumes. In some implementations, discrete variables 410, 412 have an RBM conditional distribution and other variables 420, 422, 440 have factorial conditional distributions. Each depicted variable 410, 412, 420, 422, 440 may comprise a set of one or more variables, with each set sharing a conditional distribution.

The factorial distributions impose an independence assumption within each set of continuous latent variables 420, 422, 440, which limits the ability of the model to capture correlations in input data 402. While the autoregressive structure mitigates this defect, the discrete global latent variables further serve to capture such correlations. The discrete nature of the RBM prior for the global variables 410, 412 can allow the model comprising models 400a and 400b to capture richly correlated discontinuous hidden factors that influence data generation.

The generative model 400a of FIG. 4A can be defined according to:

$$p ( z , ζ , h , x ) = p ( z ) {\prod }_{i} r ( {ζ}_{1 , i} \vert {z}_{1 , i} ) r ( {ζ}_{2 , i} \vert {z}_{2 , i} ) \times {\prod }_{j} p ( {h}_{j} \vert {h}_{< j} , ζ ) p ( x \vert ζ , h )$$

where p(z) is a RBM, ζ=[ζ₁, ζ₂], and r is a smoothing transformation that is applied componentwise to z. p(hⱼ|h_{<j}, ζ) is the conditional distribution defined over the j^{th} local variable set 440 using a factorial normal distribution. Optionally, the conditional on the data variable p(x|ζ, h) may be decomposed further into several factors defined on different scales of x, for instance as follows:

$$p ( x \vert ζ , h ) = p ( {x}_{0} \vert ζ , h ) {\prod }_{i} p ( {x}_{i} \vert ζ , h , {x}_{< i} )$$

Here, x₀ is some (small) initial scale, such as 2×2 or 4×4 pixels in an image-analysis context, which represents x downsampled to a very small scale. Conditioned on x₀, one may generate x₁ in the next scale, e.g., 8×8. This process may be continued until a suitable-scale image (e.g., the full-scale image) is generated. In at least the foregoing example, each conditional may be represented using a factorial distribution. In an image-analysis context, a factorial Bemoulli distribution may be used for binary images: a factorial mixture of discretized logistic distribution may be used for colored images

The example inference model 400b of FIG. 4B conditions over latent variables in a similar order as the generative model, and may thus be expressed as follows:

$$q ( z , ζ , h \vert x ) = q ( {z}_{1} \vert x ) {\prod }_{i} r ( {ζ}_{1 , i} \vert {z}_{1 , i} ) \times q ( {z}_{2} \vert x , {ζ}_{1} ) {\prod }_{k} r ( {ζ}_{2 , k} \vert {z}_{2 , k} ) {\prod }_{j} p ( {h}_{j} \vert ζ , {h}_{< j} )$$

In at least some implementations, q(z₁|x) and q(z₂|x, ζ₁) are each modeled with factorial Bemoulli distributions, and p(hⱼ|ζ, h_{<j}) represents the conditional distribution on the j^{th} group of local variables 440.

Discrete variables 410, 412 may take exponentially many joint configurations. Each joint configuration corresponds to a mixture component. These components may be mixed with p(z₁, z₂) in the generative model. During training the inference model may map each data point to a small subset of all the possible mixture components. The discrete prior may thus learn to suppress the probability of configurations that are not used by the inference model, resulting in a trained model where p(z₁, z₂) is likely to be multimodal and to assigns similar data elements 402 (e.g. images) to a common discrete mode.

Graphical models implementing inference model 400a and generative model 400b described above may be provided by a novel neural network architecture which combines residual networks with squeeze and excitation (SE) blocks (such as SE-ResNet blocks) to introduce a channel-wise attention mechanism. Such networks may be implemented by combining residual blocks, fully-connected layers, and/or convolutional layers.

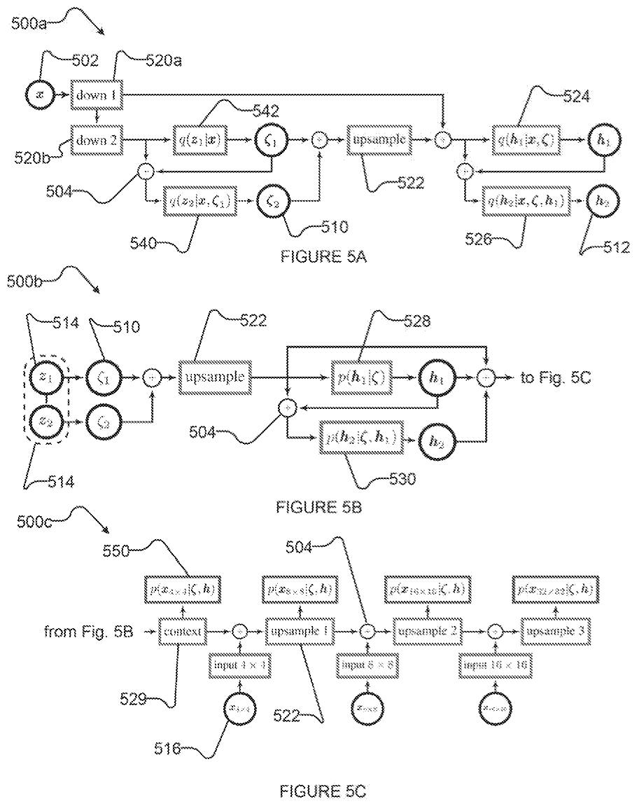

FIGS. 5A-5C (collectively and individually “FIG. 5”) show an example encoder 500a, prior 500b, and decoder 500c. In encoder 500a, a series of one or more downsampling residual blocks 520 (e.g., 520a and 520b) are used to extract convolutional features from an input 502. This residual network progressively reduces the dimensionality of features until it reaches a dimensionality of some minimal size (e.g., a feature map of size 1×1). This network outputs the low-dimensionality data as well as a higher-dimensional variant (e.g., an 8×8 feature map). For example, low-dimensional data may be generated by passing input 502 through residual blocks 520a and 520b, whereas higher-dimensional data may be passed through a small number of blocks (e.g., by avoiding 520b). The low-dimensional data is fed to one or more networks, such as fully-connected networks 540 and/or 542, which define q(zᵢ|x,ζ_{<i}) for the global latent variables. The higher-dimensional data is then fed to another set of one or more residual networks, such as residual networks 524 and/or 526, that define q(hⱼ|x,ζ, h_{<j}) for the local latent variables. (Combination nodes 504 may comprise, for example, concatenation operations.)

In prior 500b, an upsampling network 522 may be used to scale-up the global latent variables 514 (via variables 510) to an intermediate scale. The intermediate-scale output may be provided to a set of residual networks 528 and/or 530 that define p(hⱼ|ζ, h_{<j}) in the same scale. The scaled-up result may be provided to decoder 500c where another set of residual networks 522, 529 scale up the intermediate-scale samples from the latent variables to the dimensionality of the data space. In particular, in the example decoder 500c, a context network 529 maps the local latent variables to a feature space. A distribution on the smallest scale x₀ is then formed in the feature space using a residual network 522. Given samples from this scale, the distribution on the next scale is formed using another upsampling residual network 522. This process is repeated until a data space scale is reached.

If the discrete variational autoencoder is provided with many layers of latent variables, its objective function can “turn off” the majority of the latent variables in the model by matching their distribution in the inference model to the prior implemented by prior 500b. The latent units tend to be removed variably, but it is possible to modify the objective function for a VAE to balance the KL term across different sets of variables, thereby removing latent units roughly uniformly. For instance, the objective function may be modified so that the KL term for each set i is scaled by a scaling factor αᵢ proportionate to the KL term's value from the previous parameter update. Thus, large KL term values are scaled by large αᵢ, effectively penalizing them, and small KL term values are scaled by small αᵢ, effectively allowing them to grow with a reduced penalty and reducing the likelihood that they will be “turned off”.

For example, a VAE's objective function may be modified to take the following form:

$${𝔼}_{q ( Z \vert x )} [ log p ( x \vert z ) ] - γ {\sum }_{i} {α}_{i} KL ( q ( {z}_{i} \vert x ) \vert \vert p ( {z}_{i} ) )$$

where γ is annealed gradually from zero to one during training and αᵢ is the scaling term for the i^{th} set of latent variables. For example, during each parameter update αᵢ may be defined by:

$${α}_{i} = \frac{N {\hat{α}}_{i}}{{\sum }_{j} {\hat{α}}_{j}} where {\hat{α}}_{i} = {E}_{x \sim ℳ} [ KL ( q ( {z}_{i} \vert x ) \vert \vert p ( {z}_{i} ) ) ] + ϵ$$

where N is the number of sets of latent variables, [symbol] is the current mini-batch and ϵ is a small value that softens the coefficients for very small values of KL (e.g. ϵ may be in the range (0, 0.1]).

The αᵢ coefficients are applied to the objective function while the γ term is being annealed. Optionally, after γ reaches one, all of the αᵢ scaling terms may be set to one (or otherwise have their effect removed) in order to let the model optimize the variational lower bound exactly.

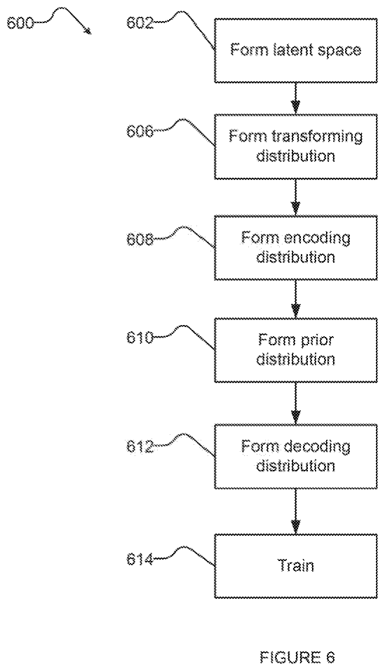

FIG. 6 shows a method 600 for unsupervised learning using smoothing transformations as described above in the context of a DVAE or other machine learning model with discrete variables in its latent space. The machine learning model performing the learning is defined over an input space which may comprise discrete and/or continuous variables. The model is trained on a set of training data and attempts to identify the value of at least one parameter that increases the log-likelihood of the training data (e.g., by minimizing the ELBO). In the course of training, the parameters of the model will be updated via a parameter-update operation and the log-likelihood of the data is a function of these parameters; for this reason, the model is sometimes said to be a function of its parameters. The model is executed by one or more processors, which may include one or more quantum processors. (For convenience, “processor” is used in the singular in the following description.)

At act 602, the processor forms a latent space with a number of random variables, including one or more discrete random variables. The latent space also includes continuous random variables that correspond to one or more of the discrete random variables of the latent space (and optionally to other variables). For example, discrete random variables may be hidden behind continuous random variables or relaxed into continuous random variables as described above. The continuous random variables in this set may be referred to as “auxiliary” or “supplementary” random variables.

At act 606, the processor forms a transforming distribution over the supplementary continuous random variables. The transforming distribution comprises a conditional distribution conditioned on the one or more discrete random variables of the latent space. In particular, the first transforming distribution comprising at least two smoothing distributions, a first one conditional on a first discrete value of the discrete random variables and a second one conditional on a second discrete value of the one or more discrete random variables. For example, the first smoothing distribution might be conditional on z=0 and the second might be conditional on z=1, as described above. The first and second smoothing distributions have the same support, so the form of the smoothing distributions can be arbitrary.

At act 608, the processor forms an encoder (i.e. an encoding distribution). This includes an approximating posterior distribution q over the latent space. The approximating posterior distribution is conditioned on the input space and maps inputs into the latent space. Encoder 500a of FIG. 5A is a non-limiting example of such an encoder.

At acts 610 and 612, the processor forms a decoder. This includes forming a prior distribution over the latent space (at act 610) and a decoding distribution over the input space (at act 612). Prior distribution 500b is a non-limiting example of such a prior distribution. The decoding distribution may be a conditional distribution over the input space conditioned on the set of supplementary continuous random variables. Decoding distribution 500c is a non-limiting example of such a decoding distribution.

At act 614, the processor trains the model based on the transforming distribution. This can involve optimizing an objective function (e.g., minimizing an ELBO) based on the transforming distribution, and in particular in some implementations it involves optimizing an ELBO based on importance sampling to determine terms associated with the transforming distribution.

Training can involve a number of steps. In at least one implementation, in the course of training the processor determines an ordered set of conditional CDFs for the supplementary continuous random variables. Each CDF may be a functions of a full distribution of at least one of the one or more discrete random variables. The processor may invert the ordered set of conditional CDFs of the supplementary continuous random variables, e.g., as described above. The processor may construct a stochastic approximation to a lower bound on the log-likelihood of the training data and/or a stochastic approximation to a gradient of the lower bound on the log-likelihood, e.g., as in gradient descent. And, during the course of optimization of the objective function, the processor may increase the lower bound on the log-likelihood based at least in part on that gradient.

In some implementations, training at 614 comprises obtaining samples from the approximating posterior (e.g., based on a QPU and/or ancestral sampling) and determining a gradient of those samples with respect to a probability of a binary state according to the approximating posterior given an input. Determining the gradient may be based on a CDF and/or PDF of the smoothing transformation, such as described above. In some implementations, the smoothing transformation is defined over a plurality of dimensions, including a latent dimension (comprising latent variables z) and one or more additional dimensions (such as temperature parameter f). Determining a gradient may involve determining the gradient of the smoothing transformation's CDF with respect to the one or more additional parameters.

### Quantum Processing

The above-described techniques may be assisted by a quantum processor, such as quantum processor 114. Training typically involves sampling over both the given data distribution (which is straightforward) the predicted model distribution (which is generally intractable). It is possible to attack this problem with certain classical approaches, such as Markov Chain Monte Carlo (MCMC), Contrastive Divergence-k (CD-k), and/or Persistent Contrastive Divergence (PCD). MCMC is slow in general, and CD-k and PCD methods tend to perform poorly when the distribution is multi-modal and the modes are separated by regions of low probability.

Even approximate sampling is NP-hard. The cost of sampling grows exponentially with problem size. In some implementations, the sampling operation is assisted by sampling from a quantum processor. It is possible to draw samples from a quantum processor which are close to a Boltzmann distribution, and it is possible to quantify the rate of convergence to a true Boltzmann distribution by evaluating the KL-divergence between the empirical distribution and the true distribution as a function of the number of samples.

Noise limits the precision with which the parameters of the model can be set in the quantum hardware. In practice, this means that the QPU is sampling from a slightly different energy function. The effects can be mitigated by sampling from the QPU and using the samples as starting points for non-quantum post-processing e.g., to initialize MCMC, CD-k, and/or PCD. The QPU is performing the hard part of the sampling process. The QPU finds a diverse set of valleys, and the post-processing operation samples within the valleys. Post-processing can be implemented in a GPU and can be at least partially overlapped with sampling in the quantum processor to reduce the impact of post-processing on the overall timing.

### Mixed-Model Training

Machine learning models may be based on classical or quantum distributions. These include Boltzmann machines and VAEs (on the classical side) and quantum Boltzmann machines (including quantum RBMs, or “qRBMs”) and quantum VAEs (or “qVAEs”) on the quantum side. A potential advantage of quantum distributions is that training may be assisted by sampling via a QPU and/or via classically-implemented and quantum-adapted techniques such as quantum Monte Carlo. However, using a quantum distribution for a machine learning model can introduce challenges in training, in part because sampling from quantum distributions in certain circumstances can be intractable.

As noted above, training a machine learning model such as a variational autoencoder may involve optimizing an objective function. Optimizing the objective function typically involves optimizing multiple terms, such as (for example) a reconstruction loss term and a difference term (such as the KL divergence) between the approximating posterior and prior, as shown above. For instance, consider the marginal log-likelihood of a VAE for a given data-point x expressed based on Jensen's inequality as follows:

$$log {p}_{θ} ( x ) \geq {𝔼}_{z \sim {q}_{φ} ( z \vert x )} [ log \frac{ {p}_{θ} ( z ) {p}_{θ} ( x \vert z )}{{q}_{φ} ( z \vert x )} ]$$

where z represents the latent variables, q_{ϕ} is the approximating posterior distribution parametrized by ϕ and p_{θ} is the generative model distribution parametrized by θ. The term [symbol] _{z˜q}_{_{θ}}_{(z|x)}[log p_{θ}(z)] is intractable and can be estimated based on a quantum distribution (e.g. via sampling). However, this term can be reduced to:

− [symbol] _{z˜q}_{_{θ}}_{(z|x)}[E(z;θ)]−log Z(θ)

where Z is the partition function and E is the energy of the Hamiltonian describing the quantum distribution. This is sometimes expressed in the more general terms—E(z; θ)−log Z(θ). The first (energy) term corresponds to the “positive phase” of Boltzmann training, which may e.g. involve estimating a gradient of the first term. The second term corresponds to the “negative phase” of Boltzmann training. Training may involve calculating derivatives (e.g., multidimensional gradients over model parameters) of terms in each phase, and those derivatives may be calculated independently for each of the phases. There are many ways to represent these phases; the foregoing equations are exemplary.

The negative phase is generally intractable, but can be approximated by sampling from the model's quantum distributions (e.g., via QPU sampling, quantum Monte Carlo). The positive phase is also intractable for quantum distributions and imposes certain constraints which can be resistant to sampling techniques. For example, certain approaches may require calculation of the probability of a given set of hidden and visible units (e.g. in the case of a qRBM) and/or marginalize a large number of variables, which may impose challenges to QPU sampling or quantum Monte Carlo sampling.

In some implementations, the positive and negative phase are calculated based on different models. For example, the negative phase can be calculated based on a quantum distribution using any suitable technique (e.g., by QPU sampling or quantum Monte Carlo sampling), whereas the positive phase can be calculated based on a classical distribution that approximates the quantum distribution. (Equivalently, the quantum distribution may approximate the classical distribution, depending on whether the target distribution of the model is quantum or classical.) This approximation introduces error into the training process, and particularly contributes looseness to the objective function, but it makes the use of quantum distributions more practical.

In some implementations, the positive phase is computed based on a classical distribution and the negative phase is computed based on a quantum distribution which corresponds to the classical distribution—for instance, if the model is based on a classical RBM, the positive phase may involve optimizing over the RBM classically (e.g., via MCMC) and the negative phase may involve optimizing over samples drawn from a quantum distribution corresponding to the RBM, such as a quantum RBM. Conversely, if the model is based on a quantum RBM, the positive phase may involve optimizing over a classical RBM corresponding to a quantum RBM and the negative phase may involve optimizing over samples drawn from the quantum RBM itself.

As an example, referring back to the earlier example definitions of positive and negative phase, calculating the positive phase −E(z; θ) may involve calculating gradients of the expectation value of the log-unnormalized probability of the samples produced by the approximating posterior based on a classical model, such as a fully-visible Boltzmann machine following a classical energy function. Calculating the negative phase may involve evaluating the derivative of the partition function Z(θ) based on samples from the corresponding quantum distribution, e.g., via the QPU, quantum Monte Carlo, or other suitable techniques.

As a further example, consider a machine learning model based on a quantum RBM. The log-probability of a given state v in the training set may be expressed as:

$$log {p}_{θ} ( v ) = log {\sum }_{\tilde{v}} {p}_{θ} ( v , \tilde{v} ) = log {\sum }_{{v}^{≂}} {\tilde{p}}_{θ} ( v , \tilde{v} ) - log Z ( θ )$$

where p_{θ}(v, \tilde{v}) is the unnormalized probability, \tilde{v} represents the state of the variables in the imaginary time (with dimensionality equal to that of \tilde{v} plus the number of Trotter slices, K), and θ are the parameters of the generative model being trained. This is an expression of the positive phase (corresponding to the derivatives of the left-hand side) and negative phase (corresponding to the derivatives of the right-hand side). Optimizing this objective function may involve calculating the gradients of the log-probability function with respect to θ. Following the foregoing, we can express p_{θ}(v, \tilde{v}) as follows:

$${p}_{θ} ( ν , \tilde{v} ) = \frac{{e}^{- \tilde{E} ( ν , \tilde{v} )}}{Z ( θ )}$$

where \tilde{E}(v, \tilde{v}) is the “effective” classical scalar Hamiltonian with added dimensionality corresponding to the Trotter expansion of the quantum Hamiltonian. That term can be expanded as follows:

$$\tilde{E} ( ν , \tilde{v} ) = - {\sum }_{i , j , k} {J}_{i , j} {v}_{i}^{k} {v}_{j}^{k} + {J}_{⊥} {v}_{i}^{k} {v}_{i}^{k + 1} + {h}_{i} {v}_{i}^{k}$$

where k iterates over the K Trotter slices (e.g. v^{k} denotes the variables at the k^{th} Trotter slice and vᵢ^{k} is the i^{th} element of v^{k}). When k=1 or k=K, v^{k} is equal to the observed visible units of the qRBM; for other indices, it is equal to the intermediate Trotter slices. The value of J_{⊥} is fixed and depends on the transverse field and the number of Trotter slices.

The derivatives of the negative phase can be calculated via QPU sampling, quantum Monte Carlo sampling, or by other means. But the derivatives of the positive phase can be challenging to calculate: for example, some approaches may require new Markov chains for each training example in the training set, which can quickly become infeasible.

It is possible to tackle this problem by assuming v=\tilde{v}, but this can introduce considerable error. In some implementations of the present disclosure, the calculation of the positive phase is addressed by adopting a variational approach to evaluating the posterior \tilde{p}_{θ}(\tilde{v}|v). This may involve, for example, introducing variational parameters ϕ and generating a proposal posterior distribution q_{ϕ}(\tilde{v}|v) (e.g. via inference networks). A variational lower bound on the log-likelihood can be defined via Jensen's inequality as follows:

$$log {p}_{θ} ( v ) \geq ℒ = {𝔼}_{\tilde{v} ∼ {q}_{φ}} ( \tilde{v} \vert v ) [ log \frac{{p}_{θ} ( \tilde{v} , v )}{{q}_{φ} ( \tilde{v} \vert v )} ] .$$

Such a qRBM may be trained by, for a given set of parameters θ, performing one or more steps of a gradient-based optimization method to obtain new values for ϕ and then updating θ based on ϕ. For example, new values of ϕ may be determined by optimizing:

$$\tilde{ℒ} = {𝔼}_{\tilde{v} ∼ {q}_{φ}} ( \tilde{v} \vert v ) [ - {\sum }_{i , j , k} {J}_{i , j} {v}_{i}^{k} {v}_{j}^{k} + {J}_{⊥} {v}_{i}^{k} {v}_{i}^{k + 1} + {h}_{i} {v}_{i}^{k} ] - {𝔼}_{\tilde{v} ∼ {q}_{φ}} ( \tilde{v} \vert v ) log {q}_{φ} ( \tilde{v} \vert v ) .$$

[symbol] has the same derivatives as [symbol] with respect to ϕ, and that derivative may be calculated analytically, depending on the form of q_{ϕ}(\tilde{v}|v). Thus, ∇_{ϕ} [symbol] can be calculated iteratively to find new values of ϕ, and those values of ϕ may be used by the positive phase model.

Updating θ based on ϕ may involve, for example, an operation of the following general form:

θ_{new}=θ−ϵ[− [symbol] _{\tilde{v}˜q}_{_{ϕ}}_{(\tilde{v}|v)}∇_{θ}\tilde{E}(v,\tilde{v})+ [symbol] _{\tilde{v}˜p}_{_{ϕ}}_{(v,\tilde{v})}∇_{θ}\tilde{E}(v,\tilde{v})]

where ϵ is the learning rate.

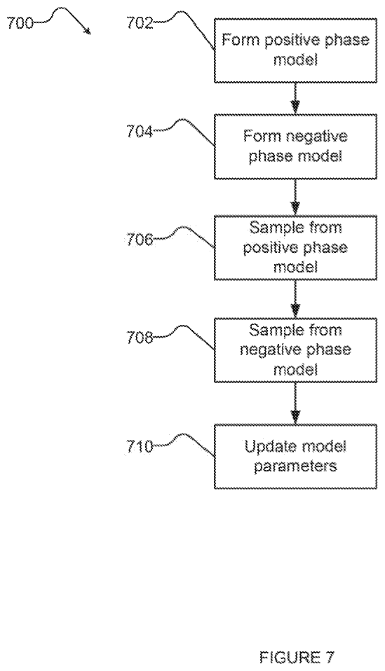

FIG. 7 is a flowchart of an example method 700 for training an example machine learning model with mixed models. The method is performed by a processor (e.g. of a digital computer), optionally in communication with a quantum processor (for implementations which use QPU sampling). The machine learning model targets a target model, such as a quantum model (i.e. a model comprising a quantum distribution) or a classical model (i.e., a model comprising a classical distribution).

At act 702 the processor forms a positive phase model and at act 704 the processor forms a negative phase model. The positive and negative phase models are different models, each of which corresponds generally (but not necessarily exactly) to the target model. For example, the positive phase model may be a classical model which approximates a quantum target model (and, e.g., the negative phase model may simply be the quantum target model). The reverse is also possible, where the negative phase model may be a quantum model which approximates a classical target model (and, e.g., the positive phase model may simply be the classical target model). Alternative (or additional) mixed-model arrangements which can be implemented by method 700 are described below, such as tunable-error mixed models where both the positive and negative phase target quantum models.

At act 706 the processor samples from the positive phase model during the positive phase of training and at act 708 the processor samples from the negative phase model during the negative phase of training. Act 708 may comprise sampling from a QPU and/or performing quantum Monte Carlo or another classically-implemented quantum-simulation technique.

At act 710 the processor updates the model parameters based on the samples from the positive and negative phase models. For example, the objective function may be optimized based on both first and second gradients. The first gradient relates to the positive phase and is calculated based on the samples from the positive phase model in act 706. The second gradient relates to the negative phase and is calculated based on the samples from the negative phase model in act 708. This method may be repeated over the course of training.

As alluded to above, mixed-model training is not limited to mixed classical and quantum models. FIG. 7 also describes example implementations of the following methods for tunable-error mixed model training.

### Tunable-Error Mixed Models

Although it is possible in appropriate circumstances to sample from a quantum distribution represented by a quantum processor to approximate a classical distribution (such as a classical RBM approximating a quantum RBM) or vice versa, as described above, for at least some quantum processor architectures it is not feasible to natively draw samples from a quantum distribution that exactly implements a classical distribution. This simplifies training, but since different models are being used at different stages of training some error is likely to be introduced (as the simplifying assumption that the classical and quantum distributions are equivalent is generally not correct). As a result, additional looseness is likely to be introduced to the objective function. That looseness cannot be arbitrarily made smaller at a fixed transverse field according to any known methods (at least in general), which hinders attempts at accurate training.

The looseness introduced by the mismatch between the model for the positive and negative phases can be made arbitrarily tunable. However, this is not as simple as using an identical model for both phases. Although it is possible to sample exactly from the prior distribution in the negative phase (e.g., via a QPU, various quantum Monte Carlo techniques, and/or via other methods), it is not generally tractable to calculate the positive phase exactly in finite time and with finite resources due to its association with the approximating posterior.

In some implementations, the models for the positive and negative phases target the same quantum model (referred to as the target model), but the model used in the positive phase is modified to have a higher-dimensional latent space than the model used in the negative phase. These additional dimensions are used to approximate the target model in the positive phase to an arbitrarily tunable degree. The positive phase is exact in its limit—that is, as the number of dimensions trends towards infinity, the positive phase model approaches the target model. This technique takes advantage of the particular structure that the Hamiltonian of the quantum distribution assumes in the presence of a transverse field.

In some such implementations, the state of the positive phase model (comprising both the prior and approximating posterior distributions) is modeled with one or more extra variables associated with the latent variables, thereby adding one or more auxiliary dimensions relative to the target distribution. (The extra variables can be referred to as “auxiliary variables”). In some implementations, the positive phase is calculated using a discrete-time quantum Monte Carlo algorithm; in that case, the auxiliary dimension ma be referred to as the Trotter dimension and corresponds to the Trotter slices of the algorithm. Note that it is not necessarily required that the distribution of the auxiliary variables given the distribution of observed variables be evaluated. This is convenient since (at least in the case of Trotter variables) this distribution is intractable.

In some implementations, the positive phase model modified (relative to the target distribution) by sampling from the target distribution using a discrete-time quantum Monte Carlo algorithm. This has the effect of expanding the dimensionality of the positive phase model's latent space according to the algorithm's Trotter dimensionality.

The negative phase model, by contrast, depends only on the prior distribution and thus can represent the quantum distribution exactly without necessarily adding additional dimensionality beyond the dimensionality of the target model. The prior distribution can be sampled from in substantially the same way as described elsewhere herein.

This formulation is precise, at least in the sense that use of the Golden-Thompson inequality is not necessary and the looseness of the objective function arising from the approximation in the positive phase can be made arbitrarily small. This precision is made possible even when the latent spaces of the positive and negative phases do not correspond by the fact that a D-dimensional quantum system can be mapped onto a D+1-dimensional classical system.

For example, consider a qVAE with a qRBM-structured latent space. The probability of a total set of latent variables (including their states in the Trotter dimension) can be expressed as:

$${p}_{θ} ( z ) = \frac{{e}^{- {E}_{eff} ( z ; θ )}}{Z ( θ )}$$

where E_{eff} is the effective energy of the quantum Hamiltonian, given by:

$$- {E}_{eff} ( z ; θ ) = {\sum }_{k = 1}^{K} {( {z}^{( k )} )}^{T} J {z}^{( k )} + {( {z}^{( k )} )}^{T} h + {{J}_{⊥} ( {z}^{( k )} )}^{T} {z}^{( k + 1 )}$$

where J_{⊥} has a fixed value determined by the transverse field and K is the number of Trotter slices, z^{(k)} represents the states of the vector z along Trotter slice k. (Due to periodic boundary conditions, z^{(K+1)}=z⁽¹⁾.) Variables h and J are the biases and couplings, respectively. Accordingly, the derivatives of p_{θ}(z) can be calculated with respect to θ as follows:

∇_{θ} [symbol] _{z˜q}_{_{ϕ}}_{(z|x)}log p_{θ}(z)=− [symbol] _{z˜q}_{_{ϕ}}_{(z|x)}[∇_{θ}E_{eff}(z;θ)]+ [symbol] _{z˜p}_{_{θ}}_{(z)}[∇_{θ}E_{eff}(z;θ)]

where the second term on the right-hand side can be calculated based on samples (e.g., from a QPU or quantum Monte Carlo) as described above and the first term can be calculated using a discrete-time quantum Monte Carlo technique or other suitable technique using finite additional dimensions to simulate a true quantum distribution with arbitrary precision.

Thus, one may train a qVAE based on its quantum model without assuming an equivalence between a particular classical model and a corresponding quantum model, the latter of which introduces untunable error via Jensen's inequality. Rather, its quantum model can be tunably approximated in the positive phase such that, at least in the limit, the positive phase and negative phase models converge. This effectively allows for a fully-quantum qVAE model, subject to a tunable approximation error.

### Quantum Generative Machine Learning Models

It is common in machine learning applications to use an all-to-all bipartite graph (e.g., a classical RBM) as the source of a classical Boltzmann distribution for generative machine learning models. It can be challenging to provide such a graph natively on at least some quantum processors (e.g., processors with limited inter-qubit connectivity), as certain approaches may require “chaining” series of qubits together into fragile systems (sometimes called “logical qubits”). This can be impractical to do effectively in large graphs with long chains. Moreover, as discussed above, quantum systems may not provide exact classical Boltzmann distributions and may instead approximate them with quantum distributions.

A motivation to use all-to-all connected bipartite graphs is that such graphs provide correlations between all units. To provide this feature in a topology with only local connectivity (or otherwise with a topology that does not correspond directly to topology of the units being modelled), long range correlations are needed.

Long range correlations in a quantum machine learning model may be induced by operating a quantum processor (such as a quantum annealing processor) to occupy a state near to a quantum phase transition point. Since a quantum processor is a physical, statistical system, it can generate long-range correlations near to this point.

In some implementations, a quantum machine learning model is trained by instantiating a Hamiltonian of the model near to a quantum phase transition point—e.g., within a threshold distance of the quantum phase transition point (where distance is measured according to a suitable metric of the Hamiltonian's space). Preferably, the quantum phase transition has multiple modes. Since the Hamiltonian is quantum mechanical, it can be treated as a quantum Boltzmann machine and trained in the same way—see, for example, Amin et al., Quantum Boltzmann machine, 2016, arXiv:1601.02036 [quant-ph] for suitable non-limiting training techniques.

Not even statistical system has a suitable quantum phase transition. For instance, two-dimensional statistical systems generally lack spin glass phase transitions at finite temperatures. However, higher-dimensional statistical systems can possess finite temperature spin glass phase transitions. One such system is a three-dimensional cubic lattice (e.g., with random couplings), which may be physically represented on certain quantum processors (e.g., as described in U.S. patent application Ser. No. 15/881,260). Other topologies with suitable quantum phase transitions may also, or alternatively, be used.

Accordingly, a quantum machine learning model may be structured as a quantum statistical system with three or more dimensions and having a finite-temperature quantum phase transition (such as a spin glass phase transition). During training, the Hamiltonian of the system may be tuned to so that its state is close to (e.g., within a threshold distance of) a quantum phase transition, such as a quantum phase transition with multiple modes. This can naturally induce long-range correlations between variables without necessarily requiring chains to be instantiated between those variables. Over the course of training, the system is likely to trend towards states with desirable long-range correlations by virtue of the training process seeking out configurations which optimize the objective function.

The present technique may be provided, for example, by a VAE (e.g. a DVAE). The VAE may use a quantum distribution (e.g., a qRBM) for its prior distribution and the qRBM may be provided with a phase transition-possessing structure as described above. The structure of the qRBM prior to training does not necessarily encode any knowledge of the particular problem, as problem-specific structure is developed over the course of training.

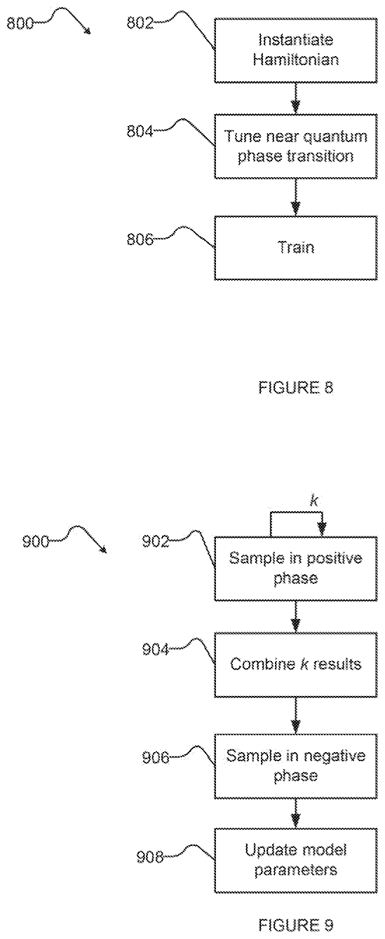

FIG. 8 is a flowchart of an example method for training an example machine learning model using quantum phase transitions. At act 802 a processor instantiates a Hamiltonian of a quantum machine learning model, such as a Hamiltonian describing a three- or higher-dimensional statistical system having a quantum phase transition (such as a finite temperature spin glass phase transition) as described above. At act 804, the Hamiltonian is tuned to be near to (e.g., within a threshold distance of) that phase transition as described above. At act 806, the quantum machine learning model is trained, e.g., by iteratively sampling from the Hamiltonian and updating the parameters of the quantum machine learning model to optimize an objective function as described above.

### Pre-Training Complex DVAEs

Training a DVAE (e.g., a DVAE with a quantum prior distribution) via a conventional approach does not necessarily lead to a sufficiently rich prior distribution for the power of sampling (e.g., by a quantum processor) to be fully exploited. In some implementations, we can promote the formation of rich prior distributions by pretraining the prior and approximating posterior distributions using a plurality of layered distributions (e.g., Boltzmann distributions represented by Boltzmann machines, such as RBMs), e.g., structured as a deep belief network (DBN).

FIG. 16 shows an example method 1600 for training a machine learning model which integrates plurality of layered distributions. At 1602, a neural network (such as a deep belief network) is formed. The network comprises the aforementioned plurality of layered distributions (e.g., Boltzmann machines). At 1604, the deep neural network is trained. Act 1604 may comprise, for example, training each layer in sequence, starting from a first layer (connected to the input), with each subsequent layer receiving the output of the previous layer as input. One all layers are trained, they form a generative model which generates samples from the topmost (i.e., last) layer machine and propagates information deterministically through the other layers. Given such a structure, what remains is to integrate it with a DVAE.

In some implementations, the prior distribution comprises the topmost layer and the decoder (i.e., the structure which produces the approximating posterior distribution) comprises the remaining layers. A prior distribution trained in this way will tend to be multimodal and complex, making it likely that it will consistently provide a rich representation. This provides a pre-trainable structure to the DVAE.

At 1606, after the network has been trained at 1604, the encoder is pre-trained to determine an initial state that is likely to correspond to a multimodal prior distribution. This may comprise minimizing an objective function for the machine learning model while the parameters of the prior distribution and the decoder are fixed (so as to retain the structure from the previous act).

At 1608, after pre-training completes, the parameters of the machine learning model (e.g., a DVAE) may be trained by any suitable means—including minimizing an objective function (this time without fixing the parameters of the prior distribution and decoder). Due to the pre-training, this training act begins from a carefully-selected initial state rather than a random state. In certain circumstances, this can help to increase the log-likelihood of the model, while also retaining the multimodal character of the prior distribution.

In some implementations, the prior distribution has sparse connectivity (e.g., because the topmost layer is a Boltzmann machine having sparse connectivity). This sparse connectivity may correspond to the connectivity of an analog processor, such as a quantum processor, e.g., as described elsewhere herein. In some implementations, the layers of the decoder may be structured non-identically so that, for example, two adjacent layers have different connectivity. For example, a first Boltzmann machine in a layer that is “further” from the prior distribution (i.e., lower-down in the hierarchy) may have greater connectivity than a second Boltzmann machine that is “closer” to the prior distribution (i.e., higher-up in the hierarchy). In some implementations, the second Boltzmann machine's graphical representation is a subgraph of the first Boltzmann machine's graphical representation—that is, the first Boltzmann machine has all of the connections of the second Boltzmann machine, and more.

In some implementations where layers comprise Boltzmann machines, each Boltzmann machine in the decoder expands on the connectivity of at least one prior Boltzmann machine (excluding, optionally, the topmost Boltzmann machine of the decoder). The connectivity of Boltzmann machines may increase with depth until, optionally, the bottommost Boltzmann machine is (or some set of bottommost Boltzmann machines are) fully-connected.

Expedited Training for qVAEs

A limiting factor in training a quantum variational autoencoder is the high training time (relative to classical VAEs), both when sampling from QPUs and via quantum Monte Carlo or similar techniques. For instance, for a qVAE with a prior implemented as a relatively-simple 16×16 bipartite quantum Boltzmann machine, the training of the qVAE could take a week or more, whereas the training of a classical VAE of similar size might be achieved in a matter of hours.

In some implementations, training is expedited by collecting more samples in the positive phase and fewer samples in the negative phase. For instance, k samples may be acquired for each input when calculating the expectations of the ELBO using a Monte Carlo approach (e.g., quantum Monte Carlo) and averaged to determine an expectation value. This reduces the variance of the ELBO, allowing the number of calls to a QPU or to quantum Monte Carlo when calculating the prior to be reduced by a factor of k, potentially expediting training considerably in circumstances where sampling from the prior is computationally expensive.

As another example, the ELBO of a variational autoencoder (e.g., a qVAE) may be modified to comprise a Renyi divergence with parameter α=1 and k important weights (e.g., in the place of a KL divergence term). This construction provides a bound that is just as tight as the KL divergence term in the ELBO of a typical VAE, but with lower variance. In particular, this modification tends to cause the standard deviation of the derivatives of the Renyi divergence with respect to the model parameters to scale proportionately to 1/√k. (Note that it is not necessary to calculate the actual importance weights due to the properties of the KL divergence; this is a consequence of setting α=1).

Although the form of a Renyi divergence with a=1 is similar to that of a KL divergence, the method of training is different (and in particular is dictated by the k importance weights). Renyi divergences may be applied to a VAE as described, for example, by Li et al., Rényi Divergence Variational Inference, 29th Conference on Neural Information Processing Systems (NIPS 2016), Barcelona, Spain, arXiv:1602.02311 v3 [stat.ML] 28 Oct. 2016, incorporated herein by reference. By making such a modification in the context of a qVAE, the computational burden of training can be rebalanced to reduce the load on costly QPU or quantum Monte Carlo operations.

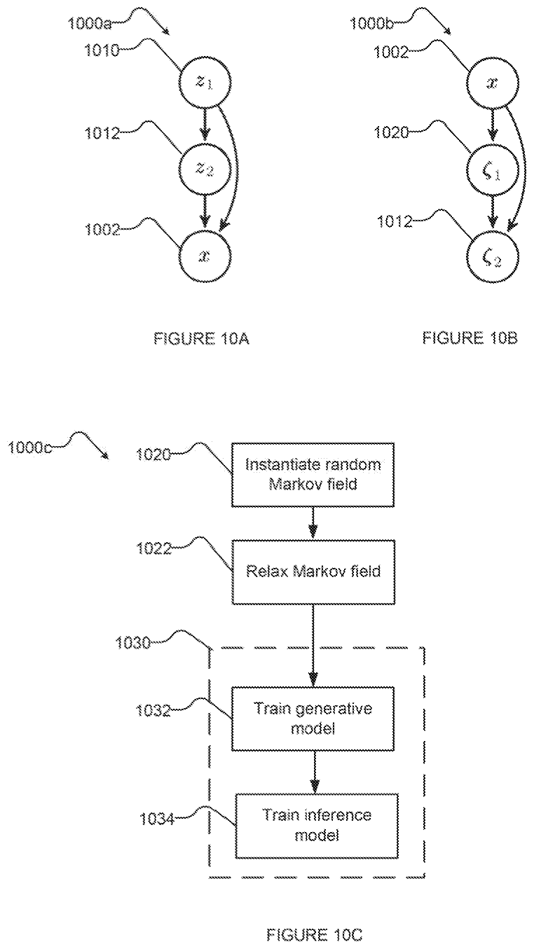

FIG. 9 is a flowchart of an example method for expedited training of an example quantum machine learning model. The method is performed by a computing system having a processor (which is optionally in communication with a quantum processor) and which has formed distributions for sampling from in both positive and negative phases. The distributions may be based on the same or different models in the different phases—that is, the method can be applied in conventional models and/or in mixed models as described above.

At act 902, a processor samples in the positive phase (e.g., by sampling from the approximating posterior and/or prior distributions), such as described above or as otherwise practiced in the art. However, the processor repeats this process k times (for k>1) and combines the results at act 906. For example, act 906 may comprise averaging the samples and determining an expectation (or other positive phase term) based on the averaged samples. As another example, act 906 may comprise determining one or more of the positive phase terms k times based on the k samples and averaging those terms. In some implementations one or more of the samples or terms are dropped out, biased, or otherwise modified so as to modify (e.g., reduce) the variance of the positive phase terms. Act 906 provides a synthesized positive phase term (which may be, for example, a gradient of a term in an objective function associated with the positive phase). Synthesized positive phase terms generated as described herein will typically have lower variance than a positive phase term generated based on one iteration of sampling.

At act 906, the processor samples in the negative phase (e.g., by sampling from the prior distribution), such as described above or as otherwise practiced in the art. Act 906 provides a negative phase term.

At act 908, the processor updates model parameters of the machine learning model based on the synthesized positive phase term and the negative phase term. Act 908 may comprise optimizing an objective function by using the synthesized positive phase term in place of the conventional positive phase term.

### Logistic Relaxation of Discrete VAEs

Boltzmann machines (and, more generally, discrete random Markov fields) can represent intractable and multimodal distributions, which makes them good candidates for providing powerful prior distributions in VAEs, particularly for VAEs having discrete latent variables. However, such constructions are resistant to the application of the so-called “reparametrization trick”, which is directed toward continuous variables. The reparametrization trick is the basis for a variety of applications of VAEs and so some constructions of DVAEs, such as those based on discrete random Markov fields (e.g. Boltzmann machines, such as some presented in PCT Publication WO 2017031356) involve marginalizing out discrete variables to enable the use of the reparametrization trick. However, such constructions can suffer from high variance, can be limited in the particular forms of smoothing distributions which are useful, and/or can have limitations in the available training techniques.

The present disclosure provides continuous proxies ζ for discrete variables of Boltzmann machines and discrete random Markov fields more generally. The proxies may be defined over the logits of the discrete variables, for example based on the following:

$$ζ = σ [ \frac{f ( l ) + f ( {σ}^{- 1} ( ρ ) )}{τ} ]$$

where f is a continuous function defined over the logits of the discrete variables, l is the logit of the binary unit z, σ is the sigmoid function

$$σ ( l ) ≡ \frac{1}{1 + exp ( - l )} ,$$

τ is a temperature parameter, and ρ is a random variable drawn from a proxy distribution. The function σ⁻¹ is sometimes called the logit function. The temperature parameter τ is optional and may be set by a user; it allows the degree of relaxation to be tunable. In some implementations, ρ is drawn from the uniform distribution [symbol] [0,1]. This construction allows for a continuous reparametrization of the discrete variables z of a random Markov field in terms of ρ.

The function ƒ defined over the logits may be learned for each discrete variable, for example by a neural network, thereby allowing a“bespoke” per-variable relaxation. However, a notable implementation of continuous proxies is the case where ƒ(l)=l for all discrete variables. In effect, this implements a Gumbel-Softmax relaxation of the discrete variables, thereby extending the so-called “Gumbel trick”, a family of techniques for providing a continuous proxy for discrete variables via the use of Gumbel-Softmax (see, e.g., Jang, E., Gu, S., and Poole, B., Categorical Reparametrization with Gumbel-Softmax (2016), arXiv preprint arXiv:1611.01144). Past constructions of the Gumbel trick (as understood) are incompatible with at least some Boltzmann machines, e.g. because the probability of a state in a Boltzmann machine is a function of the partition function (which is intractable) and/or because certain constructions require continuous probability densities in the latent space but Boltzmann machines generally provide discrete probability densities. (Indeed, the proposed techniques are incompatible with discrete random Markov fields generally for similar reasons.) The present disclosure thus, in part, provides an alternative (or additional) construction of the Gumbel trick with applicability to discrete random Markov fields.

The continuous ζ is differentiable and is equal to the discrete z in the limit τ→0. However, training stops at this limit, since discrete variables are non-differentiable. To obtain the reparametrized variable ζ, one needs the logits (or probabilities). An oracle can provide discretely-distributed samples from a Boltzmann machine or random Markov field, but as noted above this introduces challenges with applying the Gumbel trick.

For example, consider a DVAE with a prior distribution represented by a Boltzmann machine characterized by:

$${p}_{θ} ( z ) = \frac{{e}^{- {E}_{θ} ( z )}}{{Z}_{θ}}$$

where E_{θ}(z) is the energy function, Z_{θ}=Σ_{{z}}^{e-E}^{_{θ}}^{(z)} is the partition function, and z is a vector of binary variables representing the state of the Boltzmann machine. (One might optionally facilitate Gibbs-block sampling by implementing the Boltzmann machine over a bipartite graph, thereby yielding an RBM.) Such a VAE might (for example) have generative and inference models structured as shown in FIGS. 2A and 2B, respectively. If discrete latent variables 210, 212 are relaxed to continuous reparametrized variables ζ as proposed by the Gumbel trick as described above, then the generative model is likely to become intractable to train due to the general unavailability of continuous logits l.

This challenge may, in suitable circumstances, be mitigated and/or avoided by defining a continuous probability proxy \check{p}_{θ}, training a portion of the machine learning model over the proxy \check{p}_{θ}, and training the remainder of the machine learning model over the discrete variables. In particular, in the context of a DVAE having a generative model (e.g. an encoder) and an inference model (e.g. a decoder), the generative model can be trained over discrete variables z and the inference model can be trained over the proxy \check{p}_{θ}.

This may be achieved, for example, by adapting the VAE's structure to correspond to the generative model 1000a of FIG. 10A (which corresponds to model 200a: it has an input variable 1002 and discrete latent variables 1010, 1012) and inference model 1000b of FIG. 10B (which corresponds to model 200f; it has an input variable 1002 and continuous latent variables 1020, 1022) and by adopting a suitable probability proxy \check{p}_{θ}, such as:

$${\check{p}}_{θ} ( ζ ) ≡ \frac{{e}^{- {E}_{θ} ( ζ )}}{{Z}_{θ}}$$

where E_{θ}(ζ) is the energy of a relaxed Gumbel state. (Note that this proxy differs from an exact probability over ζ, which would use \tilde{Z}_{θ}≡∫_{ζ} exp−E₇₄ (ζ) in place of Z_{θ}).

Although both \tilde{Z}_{θ} and Z_{θ} are intractable, the derivatives of Z_{θ} with respect to θ can be calculated if samples from z˜p_{θ}(z) are available. For instance, the parameters θ of the generative model may be determined based on:

∇_{θ}log Z_{θ}= [symbol] ₚ_{_{θ}}_{(z)}[∇_{θ}E_{θ}(z)]

thereby allowing, in training, for potential factors to be calculated from the reparametrized Gumbel variables ζ whereas the parameters θ of the generative model may be determined based on samples from an oracle sampler over discrete z. Note that the probability proxy \check{p}_{θ}(ζ) is a lower bound on the (usually unattainable) true continuous probability p_{θ}(ζ). Moreover, note that \check{p}_{θ}→p_{θ} as τ→0; thus, when evaluating the model, it can be convenient to set τ=0 and ζ=z.

One can generate an objective function for training such a VAE using the aforementioned probability proxy (or proxies) by, for example, defining the objective function based on the following:

$$\check{ℒ} ( x ; θ , φ ) = {𝔼}_{{q}_{φ}} ( {ζ}^{i} \vert x ) [ log \frac{1}{k} {\sum }_{i = 1}^{{κ}^{´}} \frac{{e}^{- {E}_{θ} ( {ζ}^{i} )} {p}_{θ} ( x \vert {ζ}^{i} )}{{q}_{φ} ( {ζ}^{i} \vert x )} ] - log {Z}_{θ}$$

where the i superscripts refer to samples in an importance-weighted objective function with k samples. This objective function is a lower bound on an objective function defined over log Ź_{θ} (e.g. based on an exact probability over ζ), which is itself a lower bound on log p_{θ}(x) (i.e. the usual discrete objective).

Objective functions are not necessarily importance-weighted (as the above example objective function is). However, the ability to (at least in some cases) natively importance-weight the relaxed variables is a potential advantage of the presently-described relaxation technique, since the discrete variables are resistant to importance-weighting. Importance weighting can, for example, assist in reducing the effect of bias in an oracle. When quantum processors are used to generate samples, such a technique can limit bias in the gradient introduced by physical biases present in the hardware of the processor.

The foregoing lower bound defined using the probability proxy is differentiable, but introduces challenges because it mixes discrete and continuous probability densities between the generative and inference models. This can be mitigated by replacing q_{ϕ}(ζⁱ|x) with a probability proxy \check{q}_{ϕ}(ζⁱ|x), which may be defined by replacing the partition function \tilde{Z}_{θ} in q_{θ} with Z_{θ}. Put more generally, \check{p}_{θ} and \check{p}_{ϕ} may each by generated by substituting the relaxed variables ζ in place of discrete variables z in p_{θ} and q_{ϕ}, respectively, but otherwise retaining the z-based features of p_{θ} and q_{ϕ}. This may be implemented by, for example, providing continuous-valued inputs to p_{θ} and q_{ϕ}. Such an approach may introduce a degree of inexactness, but not necessarily a fatal one, as noted above.

An example objective function which may be convenient for training and/or evaluation using \check{q}_{ϕ} may be based on the following:

$${ℱ}_{k} ( x ; θ , φ ) = {𝔼}_{{q}_{φ}} ( {ζ}^{i} \vert x ) [ log \frac{1}{k} {\sum }_{i = 1}^{{κ}^{´}} \frac{{e}^{- {E}_{θ} ( {ζ}^{i} )} {p}_{θ} ( x \vert {ζ}^{i} )}{{\check{q}}_{φ} ( {ζ}^{i} \vert x )} ] - stop\_gradient ( log {Z}_{θ} - {𝔼}_{{p}_{θ} ( z )} [ {𝔼}_{θ} ( z ) ] ) + {𝔼}_{{p}_{θ} ( z )} [ {𝔼}_{θ} ( z ) ]$$

where the stop_gradient( ) function maintains the value of its argument but decimates its derivatives. Setting the temperature τ to zero in evaluation allows for unbiased evaluation of the objective function, whereas during generation discrete samples (from an oracle) can be provided to the decoder to obtain probabilities for each input dimension.

Alternatively, or in addition, one may determine the gradients of the foregoing objective function using a “straight-through” approach, where discrete zⁱ is passed when determining the E_{θ}(ζⁱ) term. It is also not generally necessary to evaluate log Z_{θ} in training, although it may be evaluated for all or a subset of iterations. Its value can, for example, be estimated using parallel tempering during evaluation.

In some implementations, a DVAE's generative model (including prior and posterior distributions) is defined over one or more continuous relaxations of the discrete variables (e.g. according to a GUMBEL distribution). The model may be defined over an RBM or other discrete random Markov field, and the continuous relaxations may thus, together, represent a continuous relaxation of the RBM or other discrete random Markov field. (We have taken to calling a Gumbel-relaxed distribution representing a Boltzmann machine a GumBolt machine). Such an embodiment does not necessarily require smoothing distributions or the noisy reparametrizations of the REINFORCE or analogous techniques. The result is a potentially-lower-noise DVAE with natively-reparametrizable variables.

In some implementations, a fully-discrete DVAE is provided by forming the prior distribution hierarchically as a (restricted) GumBolt machine and conditioning one or more discrete variables (e.g. Bernoulli-distributed variables) over the GumBolt machine. Since the GumBolt machine provides reparametrizable GUMBEL variables, the discrete variables can be conditioned directly on those GUMBEL variables without requiring conditioning on intervening continuous variables (e.g. based on a smoothing transformation). This avoidance of continuous (e.g., Gaussian) intervening variables can considerably improve the performance of the model.

FIG. 10C is a flowchart of an example method for training an example natively-reparametrizable DVAE. At act 1020 a processor instantiates a random Markov field (e.g., a Boltzmann machine and/or an RBM). At act 1022 the processor defines continuous relaxations for the discrete variables of the random Markov field and applies them to an inference model of the DVAE, yielding a relaxed inference model (such as inference model 1000b). The relaxation may comprise a continuous proxy of a probability distribution, such as a relaxation defined according to the Gumbel trick as described above and/or a per-variable relaxation of discrete variables' logits which may vary between variables. The proxy may be adapted to use a discrete partition function in place of a continuous partition function.

At 1030 the processor trains the DVAE, in particular by training a generative model 1032 over the discrete variables of the random Markov field and by training the relaxed inference model over the continuous relaxations of the discrete variables. Training may involve sampling from an oracle to determine a gradient of one or more objective functions over model parameters. Samples may, for example, be drawn from a quantum processor. The objective function(s) may optionally be importance-weighted (e.g., as described above) to address bias in the quantum processor.

### Gaussian Integral Relaxation of Discrete VAEs

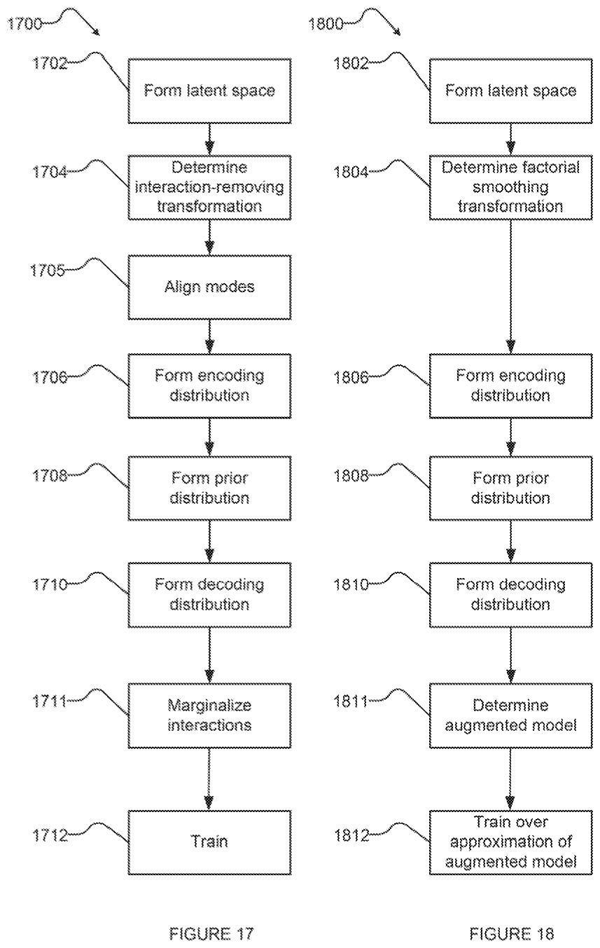

Boltzmann machine-based DVAEs may be relaxed using a variation of the Gaussian integral trick, a technique previously used for sampling. In particular, we can relax a Boltzmann machine to a continuous distribution such that the marginalization over z in p(ζ)=Σ_{z} p(z)r(ζ|z) is made tractable for arbitrary p(z) (e.g., hierarchical, factorial, and other distributions, including non-factorial distributions). An example method 1700 for relaxing an example Boltzmann machine-based DVAE is shown in FIG. 17. At 1702 a processor forms a latent space, e.g. based on a Boltzmann distribution.

A Boltzmann distribution may be described by p(z)=e^{-E}^{_{θ}}^{(z)}/Z_{θ} where E_{θ}(z) is the energy term and Z_{θ} is the partition function. The energy function may be described by E_{θ}(z)=−a^{T}z−1/2z^{t}Wz, where a is a linear bias term and W is a matrix of pairwise interactions. At 1704 the processor determines a smoothing transformation r(ζ|z) which removes pairwise interactions (e.g. as represented by z^{T} Wz) from the joint distribution p(ζ, z). In some implementations, the smoothing transformation is defined based on the Gaussian integral trick to remove the pairwise interactions z^{T}Wz from the joint p(z, ζ). For example, a smoothing transformation r(ζ|z) may be based on:

r(ζ|z)= [symbol] (ζ|A(W+βI)z,A(W+βI)A^{T})

where A is an invertible matrix and βI is an optional diagonal matrix introduced to ensure that the covariance matrix A(W+βI)A^{T} is positive definite (we can set β>0 for this purpose). We can refer to W′=W+βI as the modified interaction matrix.

A can be any invertible matrix. For instance, we might select A=I or A=Λ^{1/2}V^{T} where VΛV^{T} is the eigendecomposition of W′. However, neither of these options is expected to align the modes in p(ζ) with the vertices of a hypercube defined in [symbol] ^{D}. In some implementations (and optionally at 1705, which may form part of 1704), the modes of p(ζ) are aligned with the vertices of a D-dimensional hypercube by defining A based on the modified interaction matrix, e.g. by inverting it (i.e. so that A=W′⁻¹). This yields the smoothing transformation r(ζ|z)= [symbol] (ζ|z, (W+βI)⁻¹).

Acts 1706, 1708, and 1710 correspond generally to acts 606, 608, and 610, respectively, of method 600 (see FIG. 6). Optionally, at act 1711, a probability distribution over the continuous variables, i.e. p(θ), is determined based on the smoothing transformation determined at 1704 and particularly based on the removal of pairwise interactions. For instance, the foregoing example smoothing distribution has a joint distribution described by:

p(z,ζ)∝exp[−1/2ζ^{T}W′ζ+z^{T}W′ζ+(a−1/2βu)^{T}ζ]

where u is a D-dimensional identity vector (e.g., a vector having D ones). Since there are no pairwise terms over the discrete variables (by design), they can be marginalized out to arrive at p(ζ), e.g. as follows:

$$p ( ζ ) = {Z}_{θ}^{- 1} {\vert \frac{1}{2 π} {W}^{′} \vert}^{\frac{1}{2}} exp [ - \frac{1}{2} {ζ}^{T} {W}^{′} ζ ] {\prod }_{i} [ 1 + exp [ {a}_{i} + {c}_{i} - \frac{β}{2} ] ]$$

where cᵢ is the i^{th} element of the vector W′ζ.

Once such a probability distribution over ζ has been determined based on the pairwise-interaction-removing smoothing transformation, that distribution (and/or associated terms, such as its CDF, PDF, and/or gradients thereof) may be used in the objective function to train the model (at 1712) over a relaxation of the Boltzman machine-structured prior distribution. For instance, p(ζ) may be used in place of p(z) in the objective function.

This approach can be regarded as providing a mixture of Gaussian distributions with 2^{D} mixture components, each centered at a vertex of the hypercube in [symbol] ^{D} with mixing coefficients equal to the probability of the corresponding discrete state z. Each component has a covariance matrix W′⁻¹. As β gets larger, the covariance matrix shifts toward a matrix with dominant entries along the diagonal, so that as β→∞ each mixture component converges to a delta distribution centered at the discrete states (e.g. z=0, z=1) and p(ζ) approaches Σ_{z} p(z)δ(ζ−z).

The β parameter can be set to any suitable value. In some implementations, β is set to have a magnitude greater than the highest-magnitude negative eigenvalue of W to ensure that W′ is positive definite. Larger values of β will tend to shift the mixture distribution towards isotropic Gaussian distributions (which is often desirable), but at the cost of causing the resulting continuous distributions to be sharper and thus have noisier gradients.

As with the logit-based relaxations described above, the resulting continuous distributions are amenable to a variety of existing techniques and methods which are challenging (or even impossible) to apply directly to discrete-valued, Boltzmann machine-based DVAEs.

In some implementations, smoothing distributions of the foregoing form are used in association with the prior distribution (e.g., in the encoder) and a smoothing distribution of a different form is used in association with the approximating posterior (e.g. in the decoder) during training at 1712 and/or during inference. Since the approximating posterior distribution may not be (and in fact usually is not) structured as a Boltzmann machine, and since the W′ term of the Gaussian integral trick replicates pairwise interactions arising from the Boltzmann machine, it may be advantageous to use smoothing transformations of different forms in association with the prior and approximating distributions. For example, any of the smoothing transformations described elsewhere herein may be used in association with the approximating posterior.

In some implementations, the smoothing transformation used in association with the approximating posterior is based on a Gaussian distribution, such as

$$r ( ζ \vert z ) = ( ζ \vert z , \frac{1}{β} ) ,$$

which is an unbounded transformation (as opposed to, e.g., a transformation over ζ∈[0,1]).

In some implementations, the smoothing transformation used in association with the approximating posterior is based on a distribution with shifted modes. An example of such a transformation is a shifted Gaussian distribution defined based on

$$r ( ζ \vert z ) = ( ζ \vert z + Δ μ , \frac{1}{β} ) ,$$

where Δμ is an additional parameter that shifts the location of the modes around the states of the discrete variables z (e.g., 0 and 1). In some implementations, Δμ is a function of previous ζs in the model (e.g., by way of a hierarchical structure), which may assist with representing off-diagonal correlations.

A potential advantage of using a shifted transformation is that it may provide more flexibility, in suitable circumstances, in capturing correlations from the prior distribution. This is because each mixture component in the relaxed prior distribution p(ζ) produced by the Gaussian integral trick may contain off-diagonal correlations which are not necessarily captured by Gaussian distributions centered on the states of the discrete variables z (such as

$$r ( ζ \vert z ) = ( ζ \vert z , \frac{1}{β} ) ) .$$

### Mean Field Relaxation of Discrete VAEs

As noted above, we can train a machine learning model over a relaxation of its prior distribution by determining a continuous marginal distribution p(ζ)=Σ_{z} p(z)r(ζ|z), where r(ζ|z) is an overlapping smoothing transformation. Some specific smoothing transformations which are useful for broad ranges of models (and particularly for Boltzmann-machine-based DVAEs) are given above. But it is also possible to train over a relaxation of Boltzmann machine (or other prior distributions) with any of a broad range of smoothing transformations given a suitable prior distribution.

To train a DVAE using the relaxation p(ζ) in association with the prior distribution, we can compute log p(ζ) and its gradient with respect to the parameters of the model and ζ. This involves marginalization over z, which is generally intractable. However, if r(ζ|z) is factorial (i.e., if r(ζ|z)=Πᵢ r(ζᵢ|zᵢ)) then mean field estimation can be used to efficiently approximate the marginalization.

FIG. 18 shows an example method 1800 for training a machine learning model based on mean-field estimation. Act 1802 corresponds generally to act 602 of method 600 (see FIG. 6). At 1804, a processor determines a factorial smoothing transformation (e.g., by receiving it from a user, selecting it from a repository of suitable transformations, or by other suitable approaches). The smoothing transformation may have arbitrary form, provided that it be factorially-distributed.

Acts 1806, 1808, and 1810 correspond generally to acts 606, 608, and 610, respectively, of method 600 (see FIG. 6).

Training the model (at 1811 and 1812, which may be combined) takes advantage of the factorial structure of the smoothing transformation. 1811 involves determining an augmented model which is amenable to mean-field approximation based on the factorial smoothing transformation and the model distribution.

For example, given such an arbitrary factorial smoothing distribution r(ζ|z), the log marginal distribution of ζ may be determined based on:

$$log p ( ζ ) = log ( {\sum }_{z} p ( z ) r ( ζ \vert z ) ) = log ( {\sum }_{z} exp - {E}_{θ} ( z ) + {h ( ζ )}^{T} z + b ( ζ ) ) - log {Z}_{θ}$$

where h(ζ)=log r(ζ|z=1)−log r(ζ|z=0) and b(ζ)=log r(ζ|z=0) are computed element-wise. If the smoothing transformation is defined over a temperature term (e.g. inverse temperature β, as described elsewhere herein) then h and b may also be functions of the temperature term. For example, if r(ζ|z) is a mixture of exponentials with an inverse temperature parameter β as described elsewhere herein then h and b may be defined based on: h(ζ)=(2ζ−1) and b(ζ)=−βζ−log Z_{β}.

The above expression of log p(ζ) has two terms, the first of which (the logarithm over a sum) is equivalent to determining the log partition function for a Boltzmann machine with an augmented energy function Ê_{θ,ζ}(z):=E_{θ}(z)−h(ζ)^{T}z−b(ζ). (For consistency, we can call this Boltzmann machine an “augmented Boltzmann machine” and describe it with the distribution \hat{p}(z).) As with most log partition functions, computing the partition function directly is generally intractable. This is made even more challenging when it is needed to calculate each ζ, as may be the case in implementations of the present disclosure.

However, when training at 1812, the processor can approximate \hat{p}(z) with a mean-field distribution m(z). To do this, we take advantage of the fact that each elementwise component of ζ is generated from a bimodal distribution with modes at the discrete states of z (e.g., 0 and 1). This tends to cause the bias introduced by h(ζ) to have a large magnitude for most components of ζ, which we have determined empirically tends to enable mean-field approximation methods to produce reasonably accurate approximations of \hat{p}(z).

In some implementation, log p(ζ) (and/or a gradient over that term) can be approximated by fitting (at 1812) a mean-field distribution m(z) to the augmented Boltzmann machine corresponding to the machine learning model (determined at 1811). Fitting the mean-field distribution may involve, for example, iteratively minimizing KL(m(z)∥\hat{p}(z)) for each ζ. This iterative minimization (and/or other fitting methods) may involve iteratively determining the mean-field equation m=σ(−∂Ê_{θ,ζ}(z)), where σ is the sigmoid function.

Based on the foregoing, the gradient of log p(ζ) with respect to the model parameters (such as β or θ) and the continuous variables ζ may be determined based on:

$$\begin{matrix}∇ log p ( ζ ) = - {𝔼}_{z ∼ \hat{p} ( z )} [ ∇ {\hat{E}}_{θ , ζ} ( z ) ] + {𝔼}_{z ∼ p ( z )} [ ∇ {E}_{θ} ( z ) ] \\ \approx - {𝔼}_{z ∼ m ( z )} [ ∇ {\hat{E}}_{θ , ζ} ( z ) ] + {𝔼}_{z ∼ p ( z )} [ ∇ {E}_{θ} ( z ) ] \\ = ∇ {\hat{E}}_{θ , ζ} ( m ) + {𝔼}_{z ∼ p ( z )} [ ∇ {E}_{θ} ( z ) ]\end{matrix}$$

where m is the vector representation of the mean-field solution m(z=1), determined element-wise, and the gradient operation does not act on m. The first term of this solution relates to a mean-field approximation of the energy term of a factorial distribution and the second corresponds to the negative phase of training a Boltzmann machine (which may be approximated by, for example, Monte Carlo sampling from p(z)).

A DVAE relaxed in this way may be trained at 1812 by a variety of techniques available to continuous VAEs, such as importance-weighted sampling. In some implementations using an importance-weighted objective function, the importance weights for the training bound are determined based on the mean-field energy term ∇Ê_{θ,ζ}(m). Since the mean-field distribution m(z) is optimized to approximate \hat{p}(z), determining ∇Ê_{θ,ζ}(m) corresponds approximately to computing the value of ∇ log p(ζ) up to the normalization constant. (That is, determining the negative phase term is not necessarily required for determining the importance weights.)

As noted above, this mean-field-approximation-based technique may accommodate a variety of smoothing transformations. In some implementations, the smoothing transformation is defined over a parameter β and approaches the binary variables' distribution as β increases. However, this can introduce a cost, namely having relatively noisier gradients which can impair the learning process.

In some implementations, the smoothing transformation comprises a base transformation (e.g. a mixture of exponential distributions, as described elsewhere herein) mixed with a uniform distribution. This can help the gradient stay finite as β→∞. For example, given a base transformation r(ζ|z), the smoothing transformation may be defined based on: r′(ζ|z)=(1−ϵ)r(ζ|z)+ϵ where ζ∈[0,1]. In effect, this adjusts the base distribution to be more heavy-tailed.

In some implementations, the smoothing transformation is defined based on a heavy-tailed distribution, such as a power function distribution. For example, the smoothing transformation may be based on:

$$r ( ζ \vert z ) = \{ \begin{matrix}\frac{1}{β} {ζ}^{\frac{1}{β} - 1} & if z = 0 \\ \frac{1}{β} {( 1 - ζ )}^{\frac{1}{β} - 1} & otherwise\end{matrix}$$

where ζ∈[0,1] and β>1. These conditionals correspond to the Beta distributions B(1/β, 1) and B(1,1/β), respectively.

Note that the gradient of samples from the mixture q(ζ|x)=Σ_{z} q(z|x)r(ζ|x) with respect to the parameters of the model can be determined without deriving an analytical formulation of the inverse CDF of the mixture q(ζ|x), as described elsewhere herein.

Generative Learning with Graph-Based Models

Generative learning models, such as VAEs, may be defined over input and/or output spaces comprising graphs (and/or objects representable as graphs, which will be referred to generically as “graphs” herein). For example, the generative learning model may receive representations of graph-representable objects (such as molecules) which may be encoded, at least in part, based on a recurrent neural network (RNN), such as a long short-term memory (LSTM). For example, a VAE may provide an encoder and/or decoder based on an LSTM model and/or a GRU. Such models can be very powerful in their own right, but there may be challenges to combining them with generative models such as VAEs. For example, since VAEs tend to be frugal in their use of the latent representation, and since RNNs can model certain complicated spaces fairly well on their own, it can be difficult to ensure that information is encoded in the latent space (as opposed to, say, relying on an RNN to make inferences based on series of decoded data points). This paucity of latent representational richness can make it difficult to apply various techniques which use such latent space-encoded information to achieve results (such as QSAR).

In some implementations, a generative machine learning model is trained based on multiple spanning trees. The generative machine learning model may receive linear representations of non-linear graph-representable objects; for example, it may receive string representations (e.g., in SMILES or InChI formats) of molecules (which may comprise non-linearities such as loops, e.g. in the form of aromatic rings). The VAE may encode each object based on multiple equivalent (or corresponding) linear representations, with each linear representation representing a spanning tree. Such encoding may be performed, at least partially, by an RNN. The VAE may then produce a latent representation for each node of the graph-representable input objects by combining the hidden state vectors of the multiple spanning trees (e.g., by addition, concatenation, averages, maximums).

For example, a VAE for generating molecules with desirable characteristics (e.g., potential new drugs) may receive SMILES string representations of molecules. SMILES strings can be translated into multiple spanning trees by reconstructing a molecular graph and attempting various tree traversals. The VAE may encode each of the multiple spanning trees by passing them through a recurrent neural network (e.g., an LSTM) to produce a hidden vector, and may combine the hidden vectors to produce a latent representation for each atom.

As another example, the VAE's encoder (and/or a pre-encoder preprocessor) may generate multiple equivalent linear representations for each input linear representation. For instance, an input string may be permuted to find one or more associated representations which validly represent alternative spanning trees and also ensure that certain elements of the strings correspond (e.g., elements corresponding to nodes in the graph should correspond, as the strings represent trees with corresponding nodes). Each permuted string may then be used as one of the several linear representations described above.

Since linear representations of non-linear input data “flatten” the represented objects, they are likely to introduce discontinuities into representation of information—e.g., atoms which binding relationship in a molecule may not be adjacently represented in a particular SMILES string representation of the molecule. This can frustrate the ability of a single LSTM to encode that information. These discontinuities are likely to be dependent on the order in which tree branches are traversed in encoding or reconstructing linear representations of the objects. However, linear processing of a flattened tree will tend to be efficient than a convolutional approach to traversal of the un-flattened graph, albeit with some loss of continuity. Constructing multiple linear representations with multiple spanning trees allows the generative machine learning model to represent information continuously in at least some representations, thereby increasing the richness of the latent representation.

In some implementations, the decoder of a VAE or similar generative learning model is trained to generate multiple different linear representations of flattened spanning trees. For example, the decoder may target a SMILES string of a molecule as output. If the encoder's early layers comprise a multi-tree structure, e.g., as described above (such as in a multi-tree LSTM-based VAE), the later layers of the encoder may use a linear representation of a flattened spanning tree corresponding (as closely as possible) to the reverse of the decoder's flattened spanning tree. This correspondence can help to allow the latent representation to encode the particular spanning tree used as the decoder target. In some implementations, the original tree is rooted at the end of a branch (rather than the center of a graph) in order to make it easier to generate such a reversed flattened spanning tree.

In some implementations, the generative model's latent representation for a given input is derived solely from the tree state at a single node, e.g., the root of the decoder spanning tree. For instance, the latent representation may be derived from the LSTM state at a single atom at the root of the original representation of the molecule. The number of latent variables in such a representative framework does not scale with the nodes in a tree, since the latent variables are distinct from the output of the multi-tree model. Rather, the latent representation is inferred from the multi-tree model. This inference may be done, for example, in a hierarchical manner, with all acts conditioned on the multi-tree output.

It will be appreciated that linear processing of non-linear objects as described above may involve performing loop closures during encoding and/or decoding. In some implementations, latent information is passed through loop closures by using a combination of latent representations on both sides of the loop closure. For instance, after reaching the end of a tree branch and before moving on to the next branch from a common node, the encoder and/or decoder may be provided with the latent representation from the source node in addition to (or instead of) the end of the branch. In some implementations, the combination of latent representations is commutative, since (in at least some implementations) the prediction should be the same regardless of the order of input traversal. Addition is an example of a commutative combination operation. This allows information to flow through loops being closed even in a single training pass through a flattened spanning tree.

In some implementations, a representation of a region of a spanning tree (rather than, or in addition to, a representation of a particular node) is used by the encoder and/or decoder as input at each point in the tree. For example, a tree of size one or two rooted at the current input node and/or the output of one or more graph convolutions at the input node may be used. This enables the learning of distinct embeddings for sub-trees, rather than (or in addition to) learning them through an LSTM-like encoder, and may be combined with a multi-tree encoder and/or decoder as described above. (Note that use of this approach in the decoder may induce additional consistency constraints on the output.)

In some implementations with cyclic outputs (for which multiple equivalent spanning trees may exist), loops are implicitly closed using labels. Labels may be high-dimensional (relative to the dimensionality of the decoder) and continuous, thereby limiting the potential for label collisions and enabling the definition of a continuous similarity measure.

For instance, in some or all iterations of reconstruction (e.g., for each node, edge, and/or other element in the output) the decoder may output a label associated with the reconstructed term. Once a full linear representation has been determined by the decoder (including at least loop closure labels, which may comprise, for example, loop closure characters in a string-based representation), the decoder determines a connection probability for each pair of loop closures based on the similarity between their labels. In some implementations, the label for a loop closure is based on (at least a portion of) the latent representation for the node (or region, etc.) at the loop closure. In some implementations, the label is defined separately from the latent representation, e.g., as a separately-defined vector.

In some implementations, a weight is associated with non-closure (i.e., the creation of a new node). The weight may, for example, be fixed. The cost of connecting to an existing node or creating a new node is then proportional to weight where weight may be based on the label similarity between nodes and/or the fixed weight associated with non-closure, depending on the circumstances. In such implementations, it is not necessary to preserve loop-closure markers in the linear representation produced by the decoder.

In some implementations, training involves computing a loss function based at least partially on a symmetric function d which measures the distance between a loop closure (and/or node label) and the label of a connection that closes the loop. By penalizing more distant closures, such a function effectively “pulls together” both sides of a loop closure. In some implementations, the loss function is based on one or more additional terms which penalize other (non-loop-closure) labels for being near to the loop-closure label. This can increase the probability that loops close correctly.

Linear representations can sometimes be undesirable as a decoder target. For instance, if they specify a particular, arbitrary spanning tree then it may be undesirable to encode that particular spanning tree in the latent representation. In some implementations the decoder is trained to reconstruct the latent state of all adjacent nodes (e.g., in addition to outputting the correct node at the current point), starting from the latent state associated with each node. This enforces consistency of the latent representation throughout the input objects by allowing the tree structure of input/reconstructed objects to be traversed in any order, since the latent representation of each node is a valid starting point for traversal.

Unlike a decoder over linear representations, the decoder as described above need not have implicit knowledge about the direction of tree traversal or the portion already traversed. In some implementations, the decoder specifies multiple distinct outputs, corresponding to all adjacent nodes, by defining a suitable prior. For example, such starting-point-independent reconstruction may be enabled by defining the prior based on one or more directed acyclic graphs over the latent representation of each node.

In some implementations, a prior is defined over the latent representation of all nodes. The prior for the model may be constructed from a family of priors, each member of which comprises a marginal prior over one selected node and a spanning tree comprising the conditional distribution over all the remaining adjacent nodes given the current selected node. The prior for a latent configuration may consist of the product of the marginal distribution over the selected node and the conditional distributions along a spanning tree rooted at the selected node. The conditional prior over the observed variables given the latent variables factorizes by node, so one may consider each node independently given its latent representation.

In some implementations, regressors of the machine learning model are trained based on the maximum over the prediction based on the latent representation centered at each node (rather than, or in addition to, the expectation). This renders the representation permutation-invariant. For example, in a biological context (e.g., when considering molecules for pharmacological effect and/or toxicity) where any given node could be considered the center of the biological activity of interest, each node might represent an atom of a molecule and predictions of biological activity may be made based on the latent representation centered at each node.

In some implementations, regressors are trained based on a difference (or sum, depending on the arguments' signs) between two maximums. One maximum is the maximum prediction of fit and the other maximum is the maximum prediction of anti-fit. Examples of anti-fit include (e.g., in the context of molecular pharmacology) identifying structures that target the molecule for elimination in the kidneys or which structurally block mating with the intended receptor or which increase toxicity. In some implementations, one or both of the fit and anti-fit maximums may comprise a sum over a regressor applied to the latent representation at each node, e.g. where anti-fit features are additive. For instance, in the case of toxicity, toxic functional groups are likely to be additive, so a sum may be used for that term.

In some implementations, side-information is available for one or more nodes and is included in the decoder target (and, optionally, in the encoder). Side-information can be learned for the whole tree as a function of the generative machine learning model's latent representation, thereby effectively training the generative model over the side-information in addition to the tree structure. For example, in the context of a VAE trained on molecular structures, per-node (e.g. per-atom) side-information might include charge, bond length, dihedral angle, or other atomic properties within the molecule. The properties of the whole molecule are thus learned as a function of the VAE's latent representation. This enables a massively multitask approach to training, since each class of side-information can be trained as a task. Such implementations can be advantageous, for example, when applying QSAR or similar techniques which tend to benefit from training on many tasks.

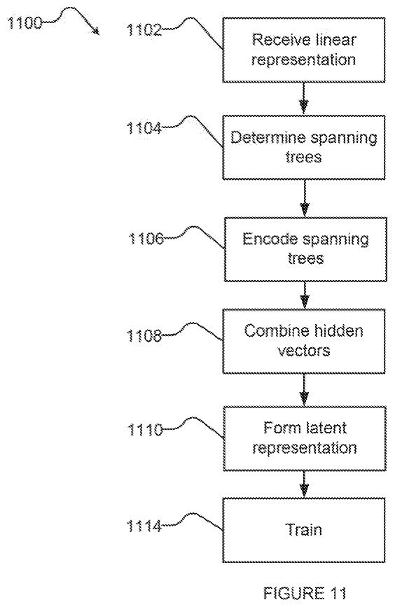

FIG. 11 is a flowchart of an example method for training an example generative machine learning model based on graph-representable inputs. At act 1102 a processor receives linear representations of a graph-representable input object, as described above. At act 1104 the processor determines a plurality of spanning trees based on a plurality of tree traversals of the input object, as described above. At act 1106 the processor encodes the plurality of spanning trees to obtain a plurality of hidden vectors corresponding to the spanning trees, as described above. Such encoding may comprise, for example, processing each of the spanning trees with an RNN (such as an LSTM). At act 1108 the hidden vectors are combined, e.g., by addition, concatenation, maximization, or another suitable technique. In some implementations, the combination technique is commutative.

At act 1110 the processor forms a latent representation based on the combination of the hidden vectors. At act 1114 the processor trains the model based on the latent representations of one or more input values, e.g. as described above. In VAE or related models, training may involve generating linear representations of graph-representable objects with a decoder based at least in part on latent representations of one or more input objects, optimizing an objective function based on the generated linear representations, and updating model parameters based on that optimization.

### Variance-Sparsifying VAEs

VAEs have a tendency to generate dense latent representations. Even if a VAE has hundreds of latent variables available to it, in many instances only a handful (e.g. concentrated largely in the first layer of the VAE's encoder) are actively used by the approximating posterior. For example, in at least one experiment involving a VAE trained to perform collaborative filtering (e.g. as described in PCT application no. US2018/065286, incorporated herein by reference) on a database of millions of user ratings (with tens of thousands of both users and items), the VAE tended to use fewer than 40 continuous latent variables regardless of the number of latent variables available to it or the size of the training set.

There are competing objectives in the design of a VAE. For instance, providing more active latent variables tends to increase the representational power of the model, while at the same time making representations less dense so that representational information is spread across a larger number of variables will tend to induce a significant cost in training. For instance, where the VAE's objective function is formulated as a difference between a KL term and a log-likelihood, the magnitude of the KL term tends to grow quickly as additional active variables are introduced.

In some implementations, a VAE is provided with one or more selectively-activatable latent variables. The activation of selectively-activatable latent variables can itself be trained, thereby allowing latent variables which are unused for certain inputs to be deactivated (or “turned off”) when appropriate and re-activated when appropriate. This is expected, in suitable circumstances, to tend to reduce the cost of temporarily-deactivated latent variables during training, thereby reducing the incentive to make the latent representation more dense (and thus leading, in at least some cases, to greater sparsity).

For example, the VAE may comprise a DVAE with a plurality of binary latent variables. Each binary latent variable (call it z) may be associated with one or more continuous latent variables (call it/them ζ), each of which is selectively-activatable. (There may, optionally, be further binary and/or continuous latent variables in the DVAE which are not necessarily related in this way.) The binary latent variables induce activation or deactivation of their associated continuous latent variables based on their state (e.g. an on state and an off state). Where the binary latent variables are elements of a trainable structure, such as a Boltzmann machine (classical and/or quantum, e.g. an RBM and/or QBM), this activation or deactivation can itself be trained.

A challenge that can arise is that the transition induced by the binary latent variables (from active to inactive) can be discontinuous, in which case the binary latent variables will not be easily trainable by gradient descent. This can be mitigated by transforming the binary latent variable to limit and/or avoid discontinuities during training (and, optionally, during inference). Some non-limiting examples of such transformations follow.

For instance, in at least some implementations where the latent binary variables are transformed according to a spike-and-exponential transformation (e.g. as described above) where the spike corresponds to the inactive state, large discontinuities may be at least partially avoided by locating the spike portion of the transformation (i.e. the Dirac delta distribution) at a point other than z=0. For example, the spike portion of the transformation can be located at the mean of the prior distribution for that variable (e.g. determined based on the earlier layers of the VAE—the location of the spike may be predetermined for the first layer, e.g. at 0).

A potential advantage of such an approach is that discretely flipping to the mean of the prior distribution will tend not to strongly disrupt reconstruction where the approximating posterior and prior are similar. It also reduces the variance of the binary latent variable to 0 when in the off state, meaning that the contribution of the associated continuous latent variable(s) to the reconstruction term can be limited when the binary latent variable is in the off state without explicitly disconnecting the continuous latent variable(s) from the decoder.

In some implementations, such a spike-and-exponential-based DVAE is trained according to a warm-up procedure wherein, during one or more initial phases of warmup, all binary latent variables are active. As training progresses to later phases, one or more (and perhaps even most) of the binary latent variables are inactive when training on each element of the dataset—the set of active binary latent variables may vary from element to element. The continuous latent variables associated with the inactive binary latent variables are removed either implicitly (e.g. by setting them to a default value, such as 0 or the mean of the continuous latent variable's prior distribution) or explicitly (e.g. by not processing the deactivated continuous latent variables in the decoder based on a logical switch).

The set of active (continuous) latent variables for a given input element may, in suitable circumstances, tend to specify a category. For example, each latent variable may correspond to a feature or component in the input space. For instance, a set of active latent variables which includes a latent variable that corresponds to cat ears, another latent variable that corresponds to furry legs, and yet another latent variable that corresponds to whiskers might suggest that the category “cat” is applicable to the given input element.

This does not mean that the value of each latent variable is irrelevant. In effect, each set of variables defines a region of the latent space within which inference may occur. For instance, in an example the latent variables are distributed based on a multivariate Gaussian over d dimensions, one can expect the probability mass of the distribution to be largely concentrated in a shell distance σ·\sqrt{d} with thickness O(σ). One can therefore expect selecting a subset of active latent variables to define a latent subspace with probability mass largely bounded away from the origin and disjoint from subspaces associated with other disjoint subsets of active latent variables. The values of the active continuous latent variables identify a point or region in the relevant latent subspace. Alternatively presented, the set of active latent variables can be thought of as identifying a set of filters to apply to the input, and the operation of each filter is dependent on the value of the corresponding active latent variable(s). This effectively separates the modes of the prior and/or approximating posterior distributions, thereby promoting sparsity.

In some implementations, the modes of the prior distribution are rebalanced (i.e. probability mass is shifted between them) even after being separated. Although this is generally not practicable with a VAE, a VAE with a discrete-valued prior as described here allows rebalancing through shifting probability between discrete points without having to “jump” across low-probability regions of the latent space.

In some implementations, the approximating posterior is defined (at least in part) as an offset on the prior distribution. This binds the two distributions together. The spike (in a spike-and-exponential embodiment) may be held close to the mean of the exponential distribution by applying a penalty based on a distance between the spike and the mean of the exponential distribution. The penalty may comprise, for example, an L2 loss and/or a measure of the probability of the spike location according to the exponential distribution (which, at least for a Gaussian distribution, is equivalent to an L2 loss with length scaled proportionately to the variance of the Gaussian distribution.) Alternatively, or additionally, the location of the exponential distribution may be parametrized so that the Gaussian is moved relative to the spike during training.

In some such implementations, during early phases of training the spikes are not used by the approximating posterior and, in the prior, the spikes are held at the mean of the exponential distribution. Later in training (i.e. after one or more iterations of the early phase), the spikes are used by the approximating posterior and can be pulled away from the mean of the exponential distribution.

In some implementations, the VAE is a convolutional VAE, where each latent variable is expandable into a feature map with a plurality (e.g. hundreds) of variables. By actively selecting a subset of latent variables for each element of the dataset (e.g. by selecting the variables with best fit for the element—e.g. those with highest probability) and turning off the rest, the number of variables which may be used by the model to store representational information may, in suitable circumstances, be increased relative to a conventional convolutional VAE.

The foregoing examples wherein continuous latent variables are activated based on the state of a binary latent variable are not exhaustive. In some implementations, the activatable continuous latent variables are activated (or deactivated) based on the state of one or more continuous latent variables. This has the potential to better represent multimodality in the approximating posterior (which is typically highly multimodal).

For example, in some implementations continuous smoothing latent variables s are defined over the set of binary latent variables such that each smoothing latent variable is associated with a corresponding binary latent variable. Smoothing latent variables may be defined over the interval [0,1], [symbol] , or any other suitable domain. Rather than (or in addition to) predicting the smoothed latent variables ζ from the binary latent variables z, the computing system predicts the binary latent variables z from the smoothed latent variables s. This allows the latent representation to change continuously, subject to the regularization of the binary latent variables z. The smoothed latent variables s may thus exhibit (for example) RBM-structured bimodality over the entire dataset.

In such an implementation, the approximating posterior and model distributions may be defined as:

q(z,s,ζ|x)=q(s|x)·q(z|s,x)·q(ζ|s,x)

p(x,s,z,ζ)=p(z)·p(s|z)·p(ζ|s)·p(x|ζ)

where q(s|x)=δ_{ƒ(x)}, i.e. the Dirac delta function centered at ƒ(x), where ƒ(x) is some deterministic function of x. Although this formulation of the smoothing variables s does not does not capture the uncertainty of the approximating posterior (or, indeed, much information at all), it can help to ensure that the autoencoding loop is not subject to excessive noise and allows for convenient analytical calculation. The q(s|x) term (a form of the approximating posterior) may be distributed to concentrate most of its probability near to the extremes of its domain, uniformly over its domain, and/or as otherwise selected by a user. Distributions which largely concentrate probability near to the values corresponding to the binary modes of the underlying binary latent variables z (as opposed to the intervening range) are likely to be the most broadly useful forms.

In some implementations, the approximating posterior and prior distributions are spectrums of Gaussian distributions, dependent on the smoothing latent variables s. When s=1, the approximating posterior may be a Gaussian dependent on the input, and the prior should be a Gaussian independent of the input. When s=0, both the approximating posterior and the prior may converge to a common Dirac delta spike independent of the input. In such an implementation, decreasing s will tend to decrease the uncertainty (e.g. the variance) and the dependence on the input of the approximating posterior, whereas for the prior only the uncertainty is decreased.

For example, the approximating posterior and prior distributions can be defined over ζ as follows:

qₛ(ζ|s,x)= [symbol] (s·μ_{q}+(1−s)·μₚ,s·σ_{q}²)pₛ(ζ|s)= [symbol] (μₚ,s·σₚ²)

where μ_{q} and σ_{q} are functions of x (and optionally, hierarchically previous ζ) and μₚ and σₚ, are not necessarily functions of x (and, optionally, are also functions of hierarchically previous ζ). These are Gaussian distributions, and so the KL term between them can be expressed as a sum of two terms, as follows:

$$K L ( {q}_{s} \vert \vert {p}_{s} ) = s \cdot \frac{{( {μ}_{q} - {μ}_{p} )}^{2}}{2 {σ}_{p}^{2}} + \frac{1}{2} ( \frac{{σ}_{q}^{2}}{{σ}_{p}^{2}} - 1 - log \frac{{σ}_{q}^{2}}{{σ}_{p}^{2}} ) .$$

The second term will be minimized when σₚ²=σ_{q}² and the first term will be minimized when s=0 or μ_{q}=μₚ. In this formulation, both qₛ and pₛ converge to a delta spike at μₚ as s→0. As a result, s governs the trade-off between the original input-dependent Gaussian approximating posterior and an input-independent noise-free distribution.

As another example, we can define the approximating posterior and prior distributions over ζ as follows:

qₛ(ζ|s,x)= [symbol] (s·μ_{q}+(1−s)·μₚ,s²·σ_{q}²+(1−s)·s·σₚ²)pₛ(ζ|s)= [symbol] (μₚ,s·σₚ²)

then the optimum remains at σ_{q}→σₚ as s→0, and the a-dependent component of the KL term decays as s→0. So long as the standard deviation of qₛ decays faster than its mean, the accuracy of the approximating posterior will generally stay roughly constant or even tend to increase as s decreases.

Further alternative (or additional) forms of qₛ and pₛ are possible: for example, one can define the mean of qₛ to be s²·μ_{q}+(1−s²)·μₚ.

The binary latent variables z may be used to govern the prior distribution over s, which can assist with the representation of multimodal distributions. For example, the prior can over s can be defined as:

$$p ( s \vert z = 0 ) = 2 \cdot ( 1 - s )$$

$$p ( s \vert z = 1 ) = 2 \cdot s$$

$$or as \text{:}$$

$$p ( s \vert z = 0 ) = β \frac{{e}^{β ( 1 - s )}}{{e}^{β} - 1}$$

$$p ( s \vert z = 1 ) = β \frac{{e}^{β s}}{{e}^{β} - 1} .$$

In either case, the prior can be defined as an a Boltzmann machine (such as an RBM) and/or a quantum Boltzmann machine (such as a QBM) over z. In the limit as β→∞, s will tend to converge to binary values corresponding to those of the underlying binary latent variables z and the distributions tend to converge to distributions similar to those of the unsmoothed variance-sparsifying VAE implementations described above.

The KL-divergence of such an implementation can be given by:

$$KL [ q ( z , s , ζ \vert x ) \vert \vert p ( z , s , ζ ) ] = {𝔼}_{q ( s \vert x ) \cdot q ( z \vert s , x ) \cdot q ( ζ \vert s , x )} [ log \frac{q ( s \vert x ) \cdot q ( z \vert s , x ) \cdot q ( ζ \vert s , x )}{p ( z ) \cdot p ( s \vert z ) \cdot p ( ζ {\vert}_{S} )} ] .$$

The values of binary latent variables do not necessarily unambiguously determine the values of the continuous latent variables in this formulation. If the spikes in the approximating posterior and prior distributions for a given smoothing continuous latent variable sᵢ do not align, then they do not interact. That is, if q(sᵢ|x)=δ_{σ}(sᵢ) and p(sᵢ|zᵢ=0)=δᵥ(sᵢ) then

$$\frac{\partial }{\partial {s}_{i}} p ( {s}_{i} \vert {z}_{i} = 0 ) = 0$$

if σ≠v.

This can pose obstacles to applying the training approach based on the cross-entropy term [symbol] _{q}[Wᵢⱼ·zᵢ·zⱼ] presented in the aforementioned paper. However, the presently-described method enables a simpler and (in at least some circumstances) lower-variance approach. In implementations where q(z|x, s, ζ)=Πᵢ q(zᵢ|x, ζ), the cross-entropy term can be reformulated as:

[symbol]

_{q}[Wᵢⱼ·zᵢ·zⱼ]=Wᵢⱼ· [symbol] _{q}[q(zᵢ=1|ζ_{k<i},x)·q(zⱼ=1|ζ_{k<j},x)].

In some implementations, the foregoing sparsification techniques are complemented by providing an Li prior, which induces sparsity (including in the hidden layers of the VAE). In some implementations this involves determining the KL term via sampling-based estimates rather than (or in addition to) analytic processes. The hidden layers of the approximating posterior and the prior distributions over binary latent variables (i.e. q(zᵢ|x, z_{j<i}) and p(zᵢ|z_{j<i}), respectively) may comprise deterministic hidden layers to assist in inducing sparsity. In at least some implementations, the means of the approximating posterior and prior distributions over the binary latent variables contract to a delta spike at the mean of the prior.

In some implementations, the VAE is a hierarchical VAE where each layer is a linear function of a plurality (e.g. all) previous layers. Each layer induces a nonlinearity, e.g. implicitly as a consequence of a sparse structure (such as by imposing the L1 prior), or by using a ReLU or other structure to provide nonlinearity. In some implementations, the output of the nonlinearity is linearly transformed to provide the parameters of a distribution describing an L1 prior for the next layer(s).

For example, the L1 prior can be provided by a Laplace distribution, with the mean and spread of the Laplace distribution being the outputs of the linear transformation of the nonlinearity's output. There are a number of forms that a Laplace distribution can take, one form that is parametrized to use a form similar to a Gaussian (but with an L1 norm) may be provided by:

$${p}_{ℒ ( μ , σ )} ( x ) = \frac{1}{2 {σ}^{2}} {e}^{- \frac{\vert x - μ \vert}{{σ}^{2}}} .$$

The prior and approximating posterior distributions over ζ corresponding to such a distribution can respectively be provided by:

pₛ(ζ|s)= [symbol] (μₚ,s·σₚ²)

qₛ(ζ|s,x)= [symbol] (s·μ_{q}+(1−s)·μₚ,s·σ_{q}²)

which may correspond to a KL term based on the following form:

$$KL ( {q}_{s} \vert \vert {p}_{s} ) = s \cdot \frac{\vert {μ}_{q} - {μ}_{p} \vert}{{σ}_{p}^{2}} .$$

Other forms of L1 prior may alternatively, or additionally, be used. These include, for example, a conventional Laplace distribution, defined by

$${p}_{ℒ ( μ , σ )} ( x ) = \frac{1}{2 σ} {e}^{- \frac{\vert x - μ \vert}{σ}} ,$$

or any other suitable distribution providing an L1 norm.

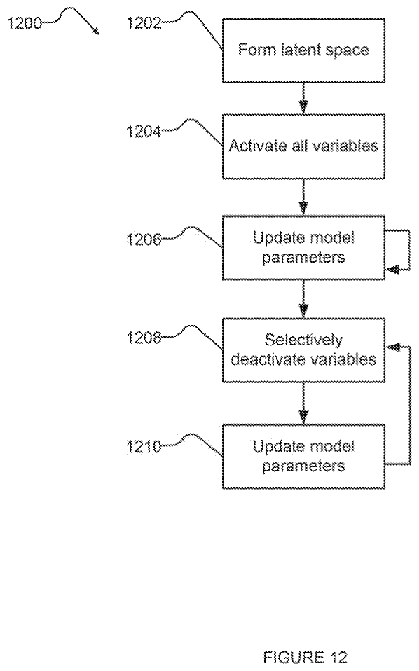

FIG. 12 is a flowchart of an example method 1200 for training a VAE with selectively-activatable continuous latent variables based on a set of binary latent variables as described above. At 1202, a computing system forms a latent space. At 1204, during at least the early phases of training, all of the selectively-activatable continuous latent variables are activated (e.g., by setting all of their corresponding binary latent variables to their “on” states). At 1206, the model parameters are updated, e.g., by computing the objective function over a training dataset, based on all of the selectively-activatable continuous latent variables being activated. This operation may occur any number of times. At 1208, one or more selectively-activatable continuous latent variables are deactivated, e.g., by setting their corresponding binary latent variables to their “off” states. This deactivating may be repeated for individual input elements of the training dataset so that different input elements correspond to different sets of active/deactivated variables. At 1210, the model parameters are updated, e.g., by computing the objective function over a training dataset, based on the subset of the selectively-activatable continuous latent variables which are activated (i.e., the deactivated selectively-activatable continuous latent variables do not contribute to the objective function, at least in respect of a particular input data element). Acts 1208 and 1210 may be performed any number of times.

Further variance-sparsifying approaches and implementations for VAEs are described in U.S. provisional patent application No. 62/731,694, incorporated herein by reference.

### Variance Reduction for DVAEs

As noted above, the KL term of at least some implementations of DVAEs can be optimized based on reparametrization techniques. However, in certain circumstances, this technique can result in the KL term having a large gradient, which can hinder effective training.

Surprisingly, the inventors have discovered that at least some implementations of DVAE deal with derivatives of the KL term in a way which is analogous to REINFORCE. This includes the spike-and-exponential-based implementations described by Rolfe, Discrete Variational Autoencoder, arXiv preprint arXiv:1609.02200 (2016), which is incorporated herein by reference.

By way of background, assuming that one wishes to calculate [symbol] =∂ [symbol] _{z˜q}_{_{ϕ}}[ƒ(z)] for some function ƒ(z), then REINFORCE works by noting that ∂q_{ϕ}=q_{ϕ}∂ log q_{ϕ} to obtain:

[symbol]

= [symbol] _{z˜q}_{_{ϕ}}[ƒ(z)∂ log q_{ϕ}].

In at least some implementations of DVAEs, ƒ(z) can be expressed as ƒ(z)=kz; k can be assumed to be 1 without loss of generality. Applying REINFORCE, one obtains:

[symbol]

= [symbol] _{z˜q}_{_{ϕ}}[z∂ log q_{ϕ}]

which further simplifies to:

[symbol]

= [symbol] _{z˜q}_{_{ϕ}}[z∂ log q]

where q is the mean of the discrete variables' distribution (e.g. the Bernoulli distribution). In the aforementioned paper, the term [symbol] is calculated as follows:

$$𝒥 = {𝔼}_{ρ ∼ 𝒰} [ \frac{1 - z ( ρ )}{1 - q} \partial q ]$$

where [symbol] is the uniform distribution.

That formulation is based on a spike-and-exponential smoothing transformation with the spike located at z=0, but the DVAE may be equivalently defined such that the spike is defined at z=1. In that case, the [symbol] term may be reduced to:

$$𝒥 = {𝔼}_{ρ ∼ 𝒰} [ \frac{z ( ρ )}{q} \partial q ]$$

which can be further reduced (based on the law of the unconscious statistician) to:

[symbol]

= [symbol] _{z˜q}_{_{ϕ}}[z∂ log q]

which is equivalent to the formulation produced by REINFORCE.

REINFORCE also tends to suffer from issues of high variance, but a number of mitigating techniques have been developed. Although it would not be expected simply by observing the structure of DVAEs, this result demonstrates that at least some implementations of DVAEs suffer from the same or similar disadvantages as REINFORCE and these effects may be mitigated using the methods applied for REINFORCE-based models.

Thus, in some implementations, the gradient of the KL term is determined (either exactly or approximately) based on REINFORCE in combination with related mitigation methods, such as control variates and/or RELAX.

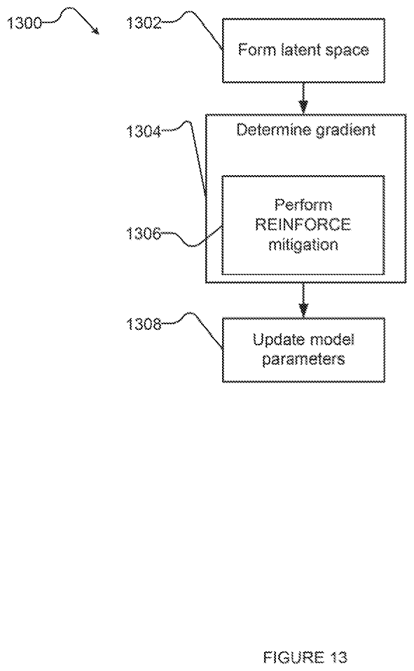

FIG. 13 is a flowchart of an example method 1300 for training a DVAE based on REINFORCE variance-mitigation techniques. At 1302 a computing system forms a latent space with discrete and continuous variables (e.g., as described elsewhere herein and in referenced works). At 1304, as part of training, the computing system constructs a stochastic approximation to a gradient of a lower bound on the log-likelihood based on training data. This operation further involves the computing system performing a REINFORCE variance-mitigation technique 1306, such as control variates and/or RELAX. At 1308 the computing system updates the model's parameters based on the gradient.

### Enhancing Local and Global Reconstruction

VAEs tend to excel at capturing high-level correlations based on their latent representations, but can lack detail at a fine-grained level. Certain other machine learning models, such as convolutional neural networks (e.g. PixeCNNs), provide powerful generative models which are well-suited to capturing fine-grained details but tend to have difficulties capturing high-level correlations. Some work has explored combining the two, such as Gulrajani et al., PixelVAE: A Latent Variable Model for Natural Images, arXiv:1611.05013 [cs.LG].

We have determined, through experiment, that in at least some circumstances the known techniques for providing a VAE with a powerful convolutional neural network as a decoder (such as a PixelCNN) can tend to lead to the latent variables of the VAE being largely unused. This can be ameliorated by scaling the size (e.g., the number of layers) of the convolutional neural network, but this can be impractical for large elements of a dataset (e.g., high-resolution images).

In some implementations, these challenges may be at least partially addressed in suitable circumstances by providing a quantum distribution, such as a quantum Boltzmann machine (e.g., a QBM) as the prior of a (D)VAE. A convolutional neural network (e.g. a PixelCNN) may be provided as the decoder. The quantum distribution can provide a powerful prior capable (in suitable circumstances) of representing complex high-level correlations and reduces the dependence of the VAE on the representational power of the convolutional neural network, at least for certain high-level correlations. This, in turn, advantageously reduces the number of layers required by the convolutional neural network.

In some implementations, the prior comprises a correlational (i.e., non-factorial) classical distribution, such as an RBM. Such implementations may, optionally, be trained based on mixed positive/negative phase models (e.g., as describe above) and/or may involve sampling from a quantum analog to the classical prior distribution via a QPU and/or via quantum Monte Carlo or other techniques.

In addition (or as an alternative) to potentially improving the performance of a computing system implementing a conventional VAE or convolutional neural network, where such approaches leverage a QPU they may also potentially improve the performance of a quantum processor (and/or a hybrid computing system comprising the quantum processor). For instance, quantum processors are often limited by the number of qubits they have available. A quantum processor of a given size may not be able to represent all of the information available in large elements of a dataset (such as high-resolution images). However, providing a QBM enables the QPU to provide samples and assist with identifying high-level correlations (e.g., as described above with respect to Quantum Generative Machine Learning Models) while allowing the convolutional neural network to “fill in” finer-grained details which may not be as easily captured by the limited-capacity QPU.

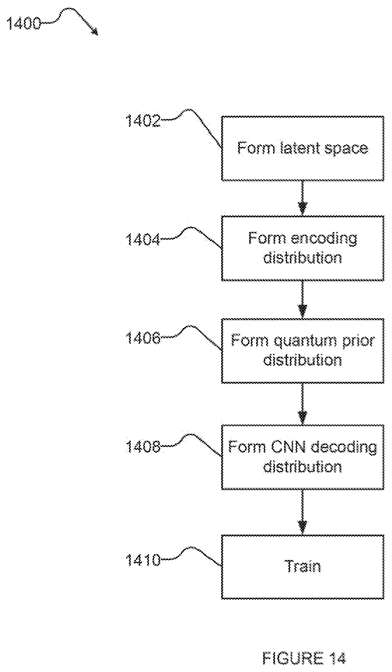

FIG. 14 is a flowchart of an example method for training a VAE with a quantum prior and a convolutional neural network decoder. At 1402 a computing system forms a latent space with at least continuous latent variables (it may also, optionally, include binary latent variables). At 1404 the computing system forms an encoding distribution—i.e., the approximating posterior distribution. At 1406 the computing system forms a prior distribution. The prior distribution is quantum distribution, such as a QBM or any other distribution representable by a QPU or quantum-simulating classical techniques (e.g. quantum Monte Carlo). At 1408 the computing system forms a decoding distribution. The decoding distribution is implemented by a convolutional neural network, such as a PixelCNN. At 1410 the computing system trains the machine learning model based on the aforementioned distributions and a set of training data.

### Importance-Weighted DVAEs

Importance sampling can be used, in suitable circumstances, to improve the training of DVAEs by providing a richer approximating posterior distribution. Importance weighting has been used with continuous VAEs, but the introduction of discrete units impedes the propagation of derivatives of the objective function through discrete units. Moreover, existing formulations of DVAEs provide for analytical objective functions, which are not readily adapted to sample-based importance-weighting approaches.

The present disclosure enables the importance-sampling of DVAEs by combining sample-based and analytical approaches to address the issue of propagating derivatives through discrete units in training.

The k-sample importance weighted estimate of the evidence lower bound (ELBO) on the log-likelihood of a VAE can be written as:

$${ℒ}_{k} ( x ) = {𝔼}_{{\{ {z}_{i} , {ζ}_{i} \}}_{i = 1}^{k} ∼ {q}_{φ}} ( {z}_{i} , {ζ}_{i} \vert x ) [ log \frac{1}{k} {\sum }_{i = 1}^{k} \frac{{p}_{θ} ( x , {z}_{i} , {ζ}_{i} )}{{q}_{φ} ( {z}_{i} , {ζ}_{i} \vert x )} ]$$

where x is an element of a training set, z and ζ are vectors of discrete and continuous latent variables, respectively, q_{ϕ} is the approximating posterior distribution parametrized by ϕ and p_{θ} is the probability distribution of the generative model parametrized θ. The terms inside the sum are unnormalized importance weights,

$${ω}_{i} ≡ \frac{{p}_{θ} ( x , {z}_{i} , {ζ}_{i} )}{{q}_{φ} ( {z}_{i} , {ζ}_{i} \vert x )} .$$

During training, the derivatives of [symbol] ₖ(x) with respect to the prior and approximating posterior parameters (θ and ϕ, respectively; their union can be expressed as Ψ) need to be calculated. This can be expressed as a function of random variables ρₗ, for example as follows:

$${∇}_{Ψ} {ℒ}_{k} ( x ) = {∇}_{Ψ} {𝔼}_{{\{ ρ ∼ 𝒰 ( 0 , 1 ) \}}_{i = 1}^{k}} [ log \frac{1}{k} {\sum }_{i = 1}^{k} \frac{{p}_{θ} ( x , {z}_{i} ( {ρ}_{i} ) , {ζ}_{i} ( {ρ}_{i} ) )}{{q}_{φ} ( {z}_{i} ( {ρ}_{i} ) , {ζ}_{i} ( {ρ}_{i} ) \vert x )} ]$$

where [symbol] (0,1) is a uniform distribution with the dimensionality of the latent space.

The discrete variables z may be reparametrized based on the Heaviside function [symbol] , e.g. as follows:

z_{i,j}(ρ_{i,j})= [symbol] (p_{i,j}−(1−q_{ϕ}(z_{i,j}(ρ_{i,j})=1|ζ_{i,j<j}(ρ_{i,j<j}),x)))

which allows for the use of the derivative of the Heaviside function,

$$\frac{\partial {q}_{j}}{\partial φ} = δ ( {ρ}_{j} - ( 1 - {q}_{j} ) ) ,$$

which (as shown below) can be useful in determining the gradient of the objective function with respect to the approximating posterior parameters ϕ. We can define q_{i,j}≡q_{ϕ}(z_{i,j}(ρ_{i,j})=1|ζ_{i,l<j}(ρ_{i,l<j}),x) for convenience.

In the case of a hierarchical DVAE, we have determined that:

$${ω}_{i} ( Ψ , x , {z}_{i} , {ζ}_{i} ) = {p}_{θ} ( {z}_{i} ) {p}_{θ} ( x \vert ζ ) {\prod }_{j = 1}^{n} \frac{1}{{q}_{φ} ( {z}_{i , j} \vert {ζ}_{i , l < j , x} )}$$

where n is the number of hierarchies (which can be assumed to be the dimensionality of the latent space without loss of generality). We can apply this formulation to express the derivative of [symbol] ₖ as follows:

$${∇}_{Ψ} {ℒ}_{k} ( x ) = {𝔼}_{{\{ {ρ}_{i} \sim 𝒰 ( 0 , 1 ) \}}_{i = 1}^{k}} [ {\sum }_{i = 1}^{k} \frac{{ω}_{i} ( Ψ , x , {z}_{i} ( {ρ}_{i} ) , {ζ}_{i} ( {ρ}_{i} ) )}{{\sum }_{{i}^{′} = 1}^{k} {ω}_{{i}^{′}} ( Ψ , x , {z}_{i} ( {ρ}_{{i}^{′}} ) , {ζ}_{{i}^{′}} ( {ρ}_{{i}^{′}} ) )} \times {∇}_{Ψ} log {ω}_{i} ( Ψ , x , {z}_{i} ( {ρ}_{i} ) , {ζ}_{i} ( {ρ}_{i} ) ) ] .$$

We can decompose the differential term of the above equation into three terms, namely a first term over discrete latent variables, a second term over input elements, and a third term over discrete latent variables conditioned on continuous latent variables and input elements:

$${∇}_{Ψ} log {ω}_{i} ( Ψ , x , {z}_{i} ( {ρ}_{i} ) , {ζ}_{i} ( {ρ}_{i} ) ) = {∇}_{Ψ} [ log {p}_{θ} ( {z}_{i} ( {ρ}_{i} ) ) + log {p}_{θ} ( x \vert {ζ}_{i} ( {ρ}_{i} ) ) - {\sum }_{j = 1}^{n} log {q}_{φ} ( {z}_{i , j} ( {ρ}_{i , j} ) \vert {ζ}_{i , l < j} ( {ρ}_{i , l < j} ) , x ) ] .$$

Differentiating the first and third terms introduce challenges in the context of a DVAE because they involve discontinuous functions of ρ_{i,j}, particularly where the discrete variables are reparametrized based on the Heaviside function.

The third term can be reformulated as:

log q_{ϕ}(z_{i,j}(ρ_{i,j})|ζ_{i,l<j}(ρ_{i,l<j}),x)=z_{i,j}(ρ_{i,j})log q_{i,j}+(1−zⱼ)log(1−q_{i,j})

or, more concisely, we can leave out implicit the subscript i and the functional dependence (ρ_{i,l<j}) to simplify the notation to:

log q_{ϕ}(zⱼ|ζ_{l<j},x)=zⱼ log qⱼ+(1−zⱼ)log(1−qⱼ).

Each of the following equations will similarly use simplified notation.

This reformulation of the third term enables an analytical determination of its derivative. Here, “analytical determination” (and other references to “analytically” or similar) means that the value of the term can be determined without necessarily sampling from the model distribution, although it may involve sampling over a reparametrization, such as ρ (which tends to be much easier). For instance, the derivative may be determined based on:

$${∇}_{Ψ} log {q}_{φ} ( {z}_{j} \vert {ζ}_{l < j} , x ) = [ log \frac{{q}_{j}}{1 - {q}_{j}} δ ( {ρ}_{j} - ( 1 - {q}_{j} ) ) + \frac{{z}_{j}}{{q}_{j}} - \frac{1 - {z}_{j}}{1 - {q}_{j}} ] \frac{\partial {q}_{j}}{\partial φ}$$

where

$$\frac{\partial {q}_{j}}{\partial φ} = δ ( {ρ}_{j} - ( 1 - {q}_{j} ) )$$

is the derivative of the Heaviside function. This analytically-determinable formulation is made possible by the above-mentioned reparametrization of z based on the Heaviside function.

The second term can be differentiated using the reparametrization trick over continuous variables ζ, which can be done analytically (and which is described in other works cited herein).

The first term can accommodate a sampling-based approach. For instance, consider a Boltzmann machine with

$${p}_{θ} ( z ) = exp \frac{( - E ( z ) )}{Z ( θ )} ,$$

where Z(θ) is the partition function as described elsewhere herein and E(z)=−Σⱼ_{₁}_{,j}_{₂}ⁿ zⱼ_{₁}Wⱼ_{₁}_{,j}_{₂}zⱼ_{₂}−Σⱼ_{₁}ⁿzⱼ_{₁}aⱼ_{₁} is the energy of state z. The derivative of the first term may be determined as follows:

−∇_{Ψ} log p_{θ}(z)=∇_{ϕ}E(z)+∇_{θ}E(z)+∇_{θ}[log Z(θ)].

This term is itself decomposed into energy terms (parametrized by θ and ϕ) and a partition term (defined over the partition function Z(θ)). The energy terms may be determined analytically (or by any other suitable method), and the partition term may be determined via a sampling-based approach. We can combine the first of these terms with the terms of [symbol] ₖ to synthesize an expectation over the first energy term as follows:

$${𝔼}_{{\{ {ρ}_{i} \sim 𝒰 ( 0 , 1 ) \}}_{i = 1}^{k}} [ {\sum }_{i = 1}^{k} \frac{{ω}_{i}}{{\sum }_{{i}^{′} = 1}^{k} {ω}_{{i}^{′}}} \times {∇}_{φ} E ( z ) ] = \\ \frac{1}{{\sum }_{{i}^{′} = 1}^{k} {ω}_{{i}^{′}}} {\sum }_{i = 1}^{k} [ {\sum }_{{j}_{1} , {j}_{2}}^{n} {\int }_{{ρ}_{i} , j \neq {j}_{1}} {ω}_{i} \frac{\partial {q}_{{j}_{1}}}{\partial φ} {W}_{{j}_{1} , {j}_{2}} {z}_{{j}_{2}} {\vert}_{{ρ}_{{j}_{1} = 1 - {q}_{{j}_{1}}}} + \\ {\int }_{{ρ}_{i} , j \neq {j}_{2}} {ω}_{i} {z}_{{j}_{1}} {W}_{{j}_{1} , {j}_{2}} \frac{\partial {q}_{{j}_{2}}}{\partial φ} {\vert}_{{ρ}_{{j}_{2}} = 1 - {q}_{{j}_{2}}} + {{\\ \sum }^{n}}_{{j}_{1}} {\int }_{{ρ}_{i} , j \neq {j}_{1}} {ω}_{i} \frac{\partial {q}_{{j}_{1}}}{\partial φ} {a}_{{j}_{1}} {\vert}_{{ρ}_{{j}_{1}} = 1 - {q}_{{j}_{1}}} ] .$$

Note that, in implementations which use a smoothing distribution of the form:

$$r ( ζ \vert z ) = \{ \begin{matrix}δ ( ζ ) & if z = 0 \\ \frac{β exp ( β ζ )}{exp ( β ) - 1} & if z = 1\end{matrix}$$

the requirement ρ_{i,j}=1−q_{i,j} translates to ζ_{i,j}(ρ_{i,j}, q_{i,j})=0, which occurs wherever z_{i,j}(ρ_{i,j})=0. This allows us to simplify to:

$${𝔼}_{{\{ {ρ}_{i} \sim 𝒰 ( 0 , 1 ) \}}_{i = 1}^{k}} [ {\sum }_{i = 1}^{k} \frac{{ω}_{i}}{{\sum }_{{i}^{′} = 1}^{k} {ω}_{{i}^{′}}} \times {∇}_{φ} E ( z ) ] = \frac{1}{{\sum }_{{i}^{′} = 1}^{k} {w}_{{i}^{′}}} {\sum }_{i = 1}^{k} {𝔼}_{{ρ}_{i}} [ {ω}_{i} [ {{\sum }^{n}}_{{j}_{1} , {j}_{2}} \frac{\partial {q}_{{j}_{1}}}{\partial φ} {W}_{{j}_{1} , {j}_{2}} {z}_{{j}_{2}} \frac{1 - {z}_{{j}_{1}}}{1 - {q}_{{j}_{1}}} + {z}_{{j}_{1}} {W}_{{j}_{1} , {j}_{2}} \frac{\partial {q}_{{j}_{2}}}{\partial φ} \frac{1 - {z}_{{j}_{2}}}{1 - {q}_{{j}_{2}}} + {{\sum }^{n}}_{{j}_{1}} \frac{\partial {q}_{{j}_{1}}}{\partial φ} {a}_{{j}_{1}} \frac{1 - {z}_{{j}_{1}}}{1 - {q}_{{j}_{1}}} ] ] .$$

The second energy term. ∇_{θ}E(z) may, at least for the above-mentioned example Boltzmann machine, be determined analytically with respect to the prior parameters θ as follows:

$$- {∇}_{θ} E ( z ) = {\sum }_{{j}_{1} , {j}_{2}}^{n} {z}_{{j}_{1}} \frac{\partial {W}_{{j}_{1} , {j}_{2}}}{\partial θ} {z}_{{j}_{2}} + {\sum }_{{j}_{1}}^{n} {z}_{{j}_{1}} \frac{\partial {a}_{{j}_{1}}}{\partial θ} .$$

The partition function term can be determined based on the behavior of the model distribution p_{θ} and sample energy:

$${∇}_{θ} [ log Z ( θ ) ] = - {p}_{θ} ( z ) \frac{\partial E ( z )}{\partial θ} .$$

This last term may be determined via a sampling-based approach, for example by obtaining one or more samples from an oracle, such as a quantum processor.

We can combine the above (with some additional derivation) to define derivatives of [symbol] ₖ with respect to the model parameters θ and ϕ. In particular, a processor may determine the derivative of [symbol] ₖ with respect to the prior parameters θ by using a sampling approach (for the partition terms) mixed with sampling-based and/or analytical approaches for the remaining terms, e.g. as shown below:

$${∇}_{θ} {ℒ}_{k} ( x ) = \frac{1}{{\sum }_{{i}^{′} = 1}^{k} {w}_{{i}^{′}}} {\sum }_{i = 1}^{k} {𝔼}_{{ρ}_{i}} [ {ω}_{i} [ {\sum }_{{j}_{1} , {j}_{2}}^{n} {z}_{{j}_{1}} \frac{\partial {W}_{{j}_{1} , {j}_{2}}}{\partial θ} {z}_{{j}_{2}} + {\sum }_{{j}_{1}}^{n} {z}_{{j}_{1}} \frac{\partial {a}_{{j}_{1}}}{\partial θ} + \frac{\partial log {p}_{θ} ( x \vert ζ )}{\partial θ} ] ] - {𝔼}_{z \sim {ρ}_{θ} ( z )} [ {\sum }_{{j}_{1} , {j}_{2}}^{n} {z}_{{j}_{1}} \frac{\partial {W}_{{j}_{1} , {j}_{2}}}{\partial θ} {z}_{{j}_{2}} + {{\sum }^{n}}_{{j}_{1}} {z}_{{j}_{1}} \frac{\partial {a}_{{j}_{1}}}{\partial θ} ]$$

which may be determined by sampling from the model distribution to solve the second expectation term (which relates to the partition term) and by solving the remaining portion analytically. The derivative with respect to the approximating posterior parameters ϕ may be determined using an analytical approach. e.g. as shown below:

$${∇}_{φ} {ℒ}_{k} ( x ) = \frac{1}{{\sum }_{{i}^{′} = 1}^{k} {w}_{{i}^{′}}} {\sum }_{i = 1}^{k} {𝔼}_{{ρ}_{i}} [ {ω}_{i} [ - {{\sum }^{n}}_{j} [ log \frac{{q}_{j}}{1 - {q}_{j}} \frac{1 - {z}_{j}}{1 - {q}_{j}} + \frac{{z}_{j}}{{q}_{j}} - \frac{1 - {z}_{j}}{1 - {q}_{j}} ] \frac{\partial {q}_{j}}{\partial φ} + {{\sum }^{n}}_{{j}_{1} , {j}_{2}} \frac{\partial {q}_{{j}_{1}}}{\partial φ} {W}_{{j}_{1} , {j}_{2}} {z}_{{j}_{2}} \frac{1 - {z}_{{j}_{1}}}{1 - {q}_{{j}_{1}}} + {z}_{{j}_{1}} {W}_{{j}_{1} , {j}_{2}} \frac{\partial {q}_{{j}_{2}}}{\partial φ} \frac{1 - {z}_{{j}_{2}}}{1 - {q}_{{j}_{2}}} + {{\sum }^{n}}_{{j}_{1}} \frac{\partial {q}_{{j}_{1}}}{\partial φ} {a}_{{j}_{1}} \frac{1 - {z}_{{j}_{1}}}{1 - {q}_{{j}_{1}}} + \frac{\partial log {p}_{θ} ( x \vert ζ )}{\partial φ} ] ]$$

which avoids the need to sample from the model distribution over q_{ϕ} by relying on the (analytically-solvable) Heaviside-based reparametrization described above.

Thus, by combining sampling-based and analytical approaches we can enable the propagation of derivatives through the discrete units. Moreover, in at least some implementations, the estimator that is obtained is unbiased. In some implementations, samples are obtained by representing a Boltzmann machine on a quantum processor, obtaining samples by evolving the quantum processor, processing the samples with a classical processor, and combining the results with the results of an analytical determination (over the remaining portion(s) of the objective function(s)) performed by a classical computer.

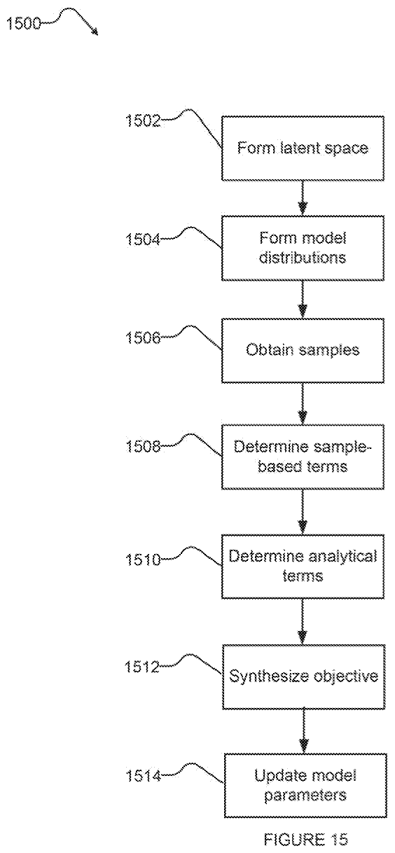

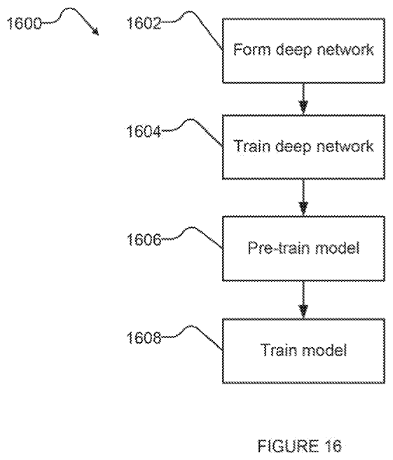

FIG. 15 shows an example method 1500 for training a machine learning model having a latent space comprising discrete variables (e.g. a DVAE) using importance-weighted sampling. At 1502 a processor forms a latent space for the model (e.g. based on a Boltzmann machine, as described above). At 1504 the processor forms one or more model distributions, such as a prior distribution and a decoding distribution (such as an approximating posterior distribution). The distributions may each be parametrized by model parameters, such as θ and ϕ mentioned above. At 1506 the processor receives one or more samples from an oracle, such as a quantum processor. Training proceeds partially based on those samples.

In particular, training is performed based on an objective function (which may be decomposed into different objective functions for each of the sets of model parameters, if desired, e.g. as described above). The objective function may be decomposed into a variety of components (called terms), such as one or more energy terms (which characterize an energy of the model) and a partition term (which describes the partition function of a model distribution). Some terms are determined based on a sampling-based approach, whereas others are determined analytically (or by other suitable approaches). At 1508, the processor determines values for the sample-based terms. For example, the processor may determine an expected value of the partition term based on the samples.

At 1510, the processor determines values for the remaining terms (e.g. the energy terms) by any suitable approach. In some implementations, 1510 involves determining values analytically (or by any other suitable approach), without necessarily requiring the use of samples from the model distribution from an oracle. Determining the values at 1510 may involve, for example, determining a gradient with respect to approximating posterior parameters ϕ of the model based on a reparametrization of the discrete variables over a proxy distribution(such as [symbol] [0,1]).

At 1512 the processor synthesizes a value for the objective function based on the terms determined at 1508 and 1510 (e.g. by determining a sum, such as shown in the above formulae). The objective function may be importance-weighted, e.g. as shown above. At 1514 the processor updates the model parameters based on the value synthesized at 1512. This method may be performed iteratively (e.g. by returning from 1514 to 1504 and/or 1506).

DVAEs with Sparse Prior Distributions

As described elsewhere herein, a discrete variational autoencoder may have a prior distribution defined over a Boltzmann machine. In some implementations, the structure of the Boltzmann machine corresponds to a topology of an analog processor (such as a quantum processor) to facilitate sampling from the Boltzmann machine's distribution by drawing samples from a representation of the Boltzmann machine encoded and executed on the analog processor.

However, often analog processors have sparse topologies (such as the so-called Chimera topology, an example of which is described in PCT patent application no. US2016/047627, which is hereby incorporated herein by reference). In some implementations, this processor-level sparsity can impose sparsity constraints on the corresponding Boltzmann machine (e.g., where the Boltzmann machine is defined over a subgraph of the processor's topology). Such sparsity constraints can limit the representational power of the Boltzmann machine. For example, some empirical tests have shown that a Chimera-structured Boltzmann machine (which is itself a form of RBM) has been found to perform similarly to a Bemoulli-distributed prior with no couplings between variables.

In some implementations, training over a prior distribution with sparse connectivity (such as over a Chimera architecture) is assisted by using a non-hierarchical approximating posterior distribution, using importance sampling in training, and using a powerful neural network in the decoder (such as a convolutional neural network). This confluence of features tends to avoid pathological regions of the latent space by tending to limit the entreating of non-existent connections, compensate for the loss of representational richness caused by the shift to a non-hierarchical approximating posterior distribution, and induce some slight overfitting. The last of these is usually undesirable, but in combination with the other features has the side-effect of promoting a relatively sharper distribution in the RBM.

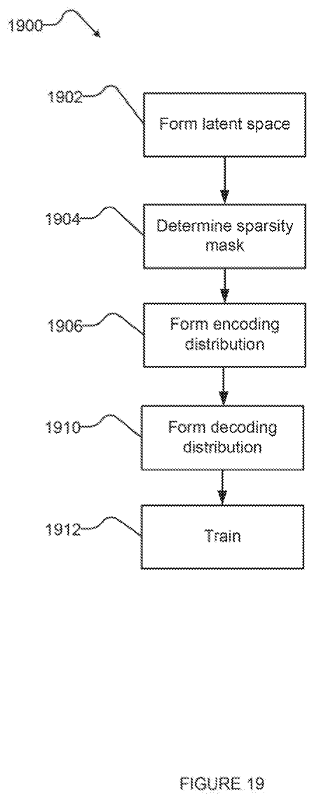

FIG. 19 shows an example method 1900 for adapting a machine learning model to a sparse underlying connectivity graph (e.g., the topology of an analog processor). Act 1902 corresponds generally to act 602 of method 600 (see FIG. 6). The machine learning model comprises a prior distribution which may be hierarchical. The prior distribution may be based on a base prior distribution which is not necessarily sparse (and/or sparse with different connectivity than the underlying connectivity graph, although this case is generally more likely to impact performance). At 1904 a processor determines a sparsity mask corresponding to the underlying connectivity graph (e.g., a Chimera graph on which the base prior distribution is based).

At 1906, the sparsity mask is applied to the base prior distribution to induce sparsity in it, thereby yielding a sparsified prior distribution. For example, the sparsity mask may be applied to the kernels of a feedforward neural network in the encoder of a DVAE. The sparsity mask removes functional dependencies between variables which do not share connections in the sparse connectivity graph. For example, a kernel matrix may be multiplied by the sparsity mask such that the element at row i and column j may be set to 0 if the stochastic units i and j do not share a connection in the sparse connectivity graph (e.g. if i and j lie on the same side of a Chimera unit cell).

For example, in case of two hierarchical layers, the approximating posterior may be based on:

q_{ϕ}(z₁,z₂|x)=q_{ϕ}(z₁|x)q_{ϕ}(z₂|z₁,x)

where q_{ϕ}(z₂|z₁, x)=nl(WWₘₐₛₖ x+b), nl is a non-linearity (e.g. one or more relu units), W and b are learnable parameters of the feedforward neural network, and Wₘₐₛₖ is the sparsity mask wherein no two variables in the sparse connectivity graph which do not share a connection are dependent on each other in Wₘₐₛₖ.

This causes the kernel of the neural network to reflect the sparsity of the underlying connectivity graph (e.g., the topology of an analog processor). The resulting distribution may then be more conveniently sampled from by an analog processor with a corresponding topology.

Acts 1910 and 1912 correspond generally to acts 610 and 612 of method 600 (see FIG. 6).

### Concluding Generalities

The above described method(s), process(es), or technique(s) could be implemented by a series of processor readable instructions stored on one or more nontransitory processor-readable media. Some examples of the above described method(s), process(es), or technique(s) method are performed in part by a specialized device such as an adiabatic quantum computer or a quantum annealer or a system to program or otherwise control operation of an adiabatic quantum computer or a quantum annealer, for instance a computer that includes at least one digital processor. The above described method(s), process(es), or technique(s) may include various acts, though those of skill in the art will appreciate that in alternative examples certain acts may be omitted and/or additional acts may be added. Those of skill in the art will appreciate that the illustrated order of the acts is shown for exemplary purposes only and may change in alternative examples. Some of the exemplary acts or operations of the above described method(s), process(es), or technique(s) are performed iteratively. Some acts of the above described method(s), process(es), or technique(s) can be performed during each iteration, after a plurality of iterations, or at the end of all the iterations.

The above description of illustrated implementations, including what is described in the Abstract, is not intended to be exhaustive or to limit the implementations to the precise forms disclosed. Although specific implementations of and examples are described herein for illustrative purposes, various equivalent modifications can be made without departing from the spirit and scope of the disclosure, as will be recognized by those skilled in the relevant art. The teachings provided herein of the various implementations can be applied to other methods of quantum computation, not necessarily the exemplary methods for quantum computation generally described above.

The various implementations described above can be combined to provide further implementations. All of the commonly assigned US patent application publications, US patent applications, foreign patents, and foreign patent applications referred to in this specification and/or listed in the Application Data Sheet are incorporated herein by reference, in their entirety, including but not limited to:

PCT application no. US2016/047627;

PCT application no. US2018/065286;

U.S. patent application Ser. No. 15/725,600;

U.S. provisional patent application No. 62/731,694;

U.S. provisional patent application No. 62/598,880;

U.S. provisional patent application No. 62/637,268;

U.S. provisional patent application No. 62/628,384;

U.S. provisional patent application No. 62/648,237;

U.S. provisional patent application No. 62/667,350; and

U.S. provisional patent application No. 62/673,013.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A method for unsupervised learning over an input space comprising discrete or continuous variables, and at least a subset of a training dataset of samples of the discrete or continuous variables, to attempt to identify a value of at least one parameter that increases a log-likelihood of the at least a subset of a training dataset with respect to a model, the model expressible as a function of the at least one parameter, the method executed by circuitry including at least one processor and comprising;
forming a latent space comprising a plurality of random variables, the plurality of random variables comprising one or more discrete random variables and a set of supplementary continuous random variables corresponding to at least a subset of the plurality of random variables;
forming a first transforming distribution comprising a conditional distribution over the set of supplementary continuous random variables, conditioned on the one or more discrete random variables of the latent space, the first transforming distribution comprising a first smoothing distribution conditional on a first discrete value of the one or more discrete random variables and a second smoothing distribution conditional on a second discrete value of the one or more discrete random variables, the first and second smoothing distributions having the same support;
forming an encoding distribution comprising an approximating posterior distribution over the latent space, conditioned on the input space;
forming a prior distribution over the latent space;
forming a decoding distribution comprising a conditional distribution over the input space conditioned on the set of supplementary continuous random variables; and
training the model based on the first transforming distribution.

2. The method according to claim 1 wherein training the model based on the first transforming distribution comprises:
determining an ordered set of conditional cumulative distribution functions of the supplementary continuous random variables, each cumulative distribution function comprising functions of a full distribution of at least one of the one or more discrete random variables of the latent space;
determining an inversion of the ordered set of conditional cumulative distribution functions of the supplementary continuous random variables;
constructing a first stochastic approximation to a lower bound on the log-likelihood of the at least a subset of a training dataset;
constructing a second stochastic approximation to a gradient of the lower bound on the log-likelihood of the at least a subset of a training dataset; and
increasing the lower bound on the log-likelihood of the at least a subset of a training dataset based at least in part on the gradient of the lower bound on the log-likelihood of the at least a subset of a training dataset.

3. The method according to claim 1 wherein the first and second smoothing distributions are one of continuous and symmetric.

4. (canceled)

5. The method according to claim 1 wherein each of the first and second smoothing distributions is selected from the group consisting of an exponential distribution, a normal distribution, and a logistic distribution.

6. The method according to claim 1 wherein forming a first transforming distribution comprises forming a first transforming distribution based on three or more smoothing distributions, each smoothing distribution converging to a mode of a distribution of the discrete random variables.

7. The method according to claim 1 wherein training the model comprises optimizing an objective function based on importance sampling to determine terms associated with the first transforming distribution.

8. The method according to claim 1 wherein forming a latent space comprises representing at least a portion of the latent space as a Boltzmann machine and wherein training the model comprises instructing a quantum processor to physically encode a quantum distribution approximating a Boltzmann distribution, instructing the quantum processor to sample from the quantum distribution, and receiving, from the quantum processor, one or more samples from the quantum distribution.

9. The method according to claim 1 wherein training the model comprises:
optimizing an objective function having a plurality of terms; and
scaling each term of a subset of the plurality of terms of the objective function by a corresponding scaling factor, each scaling factor proportional to a magnitude of a corresponding term of the objective function.

10. The method according to claim 9 wherein each magnitude of each corresponding term of the objective function was determined in a previous iteration of a parameter-update operation.

11. The method according to claim 9 wherein training the model comprises:
scaling each term of the subset by a common annealing factor, the common annealing factor annealing from an initial value to 1 during training, and
removing the scaling by the common annealing factor when the common annealing factor reaches 1.

12.-83. (canceled)

84. The method according to claim 1 wherein:
forming the encoding distribution comprising the approximating posterior distribution comprises forming the approximating posterior distribution over the set of supplementary continuous random variables conditioned on the input space; and
training the model comprises determining a gradient over one or more samples from the set of supplementary continuous random variables based on a cumulative density function of the first transforming distribution.

85. The method according to claim 84 wherein determining the gradient comprises one or more of determining the gradient with respect to a first probability yielded by the approximating posterior distribution for a first binary state of the one or more discrete random variables and determining a first value of the cumulative density function conditioned on the first binary state of the one or more discrete random variables and a second value of the cumulative density function conditioned on a second binary state of the one or more discrete random variables.

86.-89. (canceled)

90. The method according to claim 1 wherein forming the first transforming distribution comprises determining the first smoothing distribution so as to remove one or more pairwise interactions between the one or more discrete random variables.

91. The method according to claim 90 wherein determining the first smoothing distribution comprises determining the first smoothing distribution based on a Gaussian distribution with variance based on the one or more pairwise interactions between the one or more discrete random variables.

92. The method according to claim 91 wherein determining the Gaussian distribution comprises determining a modified interaction matrix based on the one or more pairwise interactions and a modifying term.

93.-99. (canceled)

100. The method according to claim 1 wherein:
forming the first transforming distribution comprises forming the first smoothing distribution and the second smoothing distribution factorially; and
training the model comprises:
determining a modified model based on the first transforming distribution and
approximating at least a portion of an objective function over the set of supplementary continuous random variables based on a mean-field approximation of the modified model.

101. The method according to claim 100 wherein the modified model comprises a distribution over the set of supplementary continuous random variables and the approximating at least a portion of the objective function comprises fitting the mean-field approximation of the modified model by minimizing a difference metric between the mean-field approximation and the modified model.

102. The method according to claim 101 wherein minimizing the difference metric comprises minimizing a Kullback-Leibler divergence.

103. The method according to claim 100 wherein:
the model comprises a Boltzmann machine;
determining the modified model comprises determining a modified Boltzmann machine based on the first transforming distribution; and
training the model comprises:
determining a first gradient over a first energy term corresponding to the modified Boltzmann machine; and
determining an expectation of a second gradient over a second energy term corresponding to the Boltzmann machine.

104.-111. (canceled)

112. A computational system, comprising:
at least one processor; and
at least one nontransitory processor-readable storage medium that stores at least one of processor-executable instructions or data which, when executed by the at least one processor, cause the at least one processor to:
form a latent space comprising a plurality of random variables, the plurality of random variables comprising one or more discrete random variables and a set of supplementary continuous random variables corresponding to at least a subset of the plurality of random variables;
form a first transforming distribution comprising a conditional distribution over the set of supplementary continuous random variables, conditioned on the one or more discrete random variables of the latent space, the first transforming distribution comprising a first smoothing distribution conditional on a first discrete value of the one or more discrete random variables and a second smoothing distribution conditional on a second discrete value of the one or more discrete random variables, the first and second smoothing distributions having the same support;
form an encoding distribution comprising an approximating posterior distribution over the latent space, conditioned on an input space comprising discrete or continuous variables;
form a prior distribution over the latent space;
form a decoding distribution comprising a conditional distribution over the input space conditioned on the set of supplementary continuous random variables; and
train a model based on the first transforming distribution.
